(19) United States
(12) Patent Application Publication
(10) Pub. No.: US 2016/0078408 A1
(43) Pub. Date: Mar. 17, 2016

(54) System and Method for Enabling and/or Managing Contributions

(71) Applicant: WEEETEEOO INC., San Jose, CA (US)

(72) Inventors: Michael Simon Vo, San Jose, CA (US); Samuel Shin-wai Chiu, Stanford, CA (US); Henry Ho-yin Tang, Ottawa (CA); Alan Paul Rolleston Phillips, Nuneaton (GB)

(73) Assignee: WEEETEEOO INC., San Jose, CA (US)

(21) Appl. No.: 14/830,229

(22) Filed: Aug. 19, 2015

Related U.S. Application Data
(60) Provisional application No. 62/039,274, filed on Aug. 19, 2014.

(51) Int. Cl. G06Q 10/10

(52) U.S. Cl. CPC G06Q 10/1057

(57) ABSTRACT

Systems, methods and computer-readable media are provided for enabling and/or managing contribution of paid time off. A system including one or more units configured for determining the value of paid time off as currency; and one or more units configured for conducting a transaction wherein paid time off is designated for contribution, and the determined value of the paid time off is designated for payment to one or more organizations is provided. Corresponding methods and computer-readable media are also provided.

### CROSS-REFERENCE TO RELATED APPLICATION

This application claims priority and the benefit of U.S. Provisional Application No. 62/039,274, SYSTEM AND METHOD FOR ENABLING AND/OR MANAGING CONTRIBUTIONS, filed on Aug. 19, 2014. This application is hereby incorporated by reference in its entirety.

### FIELD

The present disclosure relates generally to the management of contributions, and more particularly to systems, methods. and computer-readable media for managing and/or enabling contributions of paid time off.

### BACKGROUND

Traditional models of contributing to organizations and/or campaigns have involved the pledging of currency and/or other types of physical contributions, such as clothing, products, etc. However, these models have not accounted for the contribution of non-currency assets, such as an employee's accumulated paid time off, and others.

Some of the challenges with non-monetary assets such as accumulated paid time off is the valuation of these assets and the need to integrate with various systems, which are often electronic systems, to account for these contributions. For example, paid time off may be tracked by an automated payroll and/or human resources systems, and the value of paid time off may differ from individual to individual, or on various other circumstances.

### SUMMARY

The present disclosure relates to systems, methods, and computer-readable media for administering, managing and/or enabling contributions of paid time off.

In some embodiments, a system is provided for enabling and/or managing contribution of paid time off, the system including: one or more units configured for determining the value of paid time off as currency; and one or more units configured for conducting a transaction wherein paid time off is designated for contribution, and the determined value of the paid time off is designated for payment to one or more organizations.

In some embodiments, the system may be configured for integration with various external systems, which include at least one of human resources systems, social media networking systems, and financial systems.

In some embodiments, the unit for determining the value of paid time off may be configured to tracking contributions based on a set of rules and apply contribution matching policies.

In some embodiments, the system may be configured to utilize specific data structures and/or data processing technology.

In a first aspect, a computer-implemented system for administering the contribution of paid time off by a plurality of users to one or more charitable organizations is provided, the system comprising: one or more processors configured for integration with one or more human resources systems, the one or more human resources systems maintaining electronic records associated with payroll information of the one or more users of the plurality of users; one or more data storage devices storing data, the data at least including one or more indications of charitable giving preferences associated with one or more users of the plurality of users; a non-transitory computer-readable memory in communication with the one or more processors and the one or more data storage devices, the non-transitory computer-readable memory storing instructions, the instructions which when executed by the one or more processors, cause the one or more processors to: generate one or more user profiles, each user profile associated with each user of the plurality of users; receive one or more indications of charitable giving preferences associated the plurality of users; receive one or more electronic requests from the plurality of users, the one or more electronic requests indicative of an intention to donate an amount of paid time off accrued by the plurality of users; validate the one or more electronic requests by communicating the one or more electronic requests to the one or more human resources systems and receiving a signal indicative of the validation status of the one or more electronic requests; if the one or more electronic requests are valid, process the one or more electronic requests by (i) determining an approximate exchange value associated with a unit of time worked by the user associated with the electronic request based at least on the payroll information stored on the one or more human resources systems, (ii) determining a currency value associated with the amount of paid time off to be donated using at least the approximate exchange value, (iii) communicating to the one or more human resources systems an indication of the amount of paid time off that has been flagged for donation, and (iv) generating an electronic record indicative of an electronic credit equal to the currency value; receive, from the one or more human resources systems, a first electronic payment of funds in an amount based at least on the determined currency value associated with the amount of paid time off to be donated; based at least on the one or more charitable giving preferences, determine a target charitable organization; and transmit, to a computing system associated with the target charitable organization, a second electronic payment of funds in an amount based at least on the determined currency value associated with the amount of paid time off to be donated.

In another aspect, the instructions further cause the one or more processors to: generate a physical voucher based on the electronic record indicative of the electronic credit, the physical voucher denoting (i) at least the determined currency value associated with the amount of paid time off to be donated and (ii) a redemption code; and wherein the second electronic payment of funds is conditioned on receiving the redemption code from the computing system associated with the target charitable organization.

In another aspect, the instructions further cause the one or more processors to: receive an electronic indication representative of a third party entity's willingness to augment donations by the plurality of users; and wherein the second electronic payment of funds is in an amount based at least on (i) the amount of paid time off to be donated and (ii) the electronic indication representative of the third party entity's willingness to augment donations by the plurality of users.

In another aspect, the instructions further cause the one or more processors to: provide a user interface to the plurality of users, the user interface displaying at least (i) information associated with the one or more charitable organizations and (ii) information maintained in the one or more user profiles.

In another aspect, the instructions further cause the one or more processors to: maintain, in each user profile of the one or more user profiles, a virtual currency amount having a value; and increase the value of the virtual currency amount maintained on a user's profile when one or more electronic requests are successfully processed.

In another aspect, the instructions further cause the one or more processors to: electronically track activities of one or more users of the plurality of users on the one or more user profiles; and increase the value of the virtual currency amount maintained on a user's profile when the activities are detected.

In another aspect, the activities include at least one of (i) accessing the system, (ii) providing one or more electronic comments, (iii) providing one or more electronic reviews, and (iv) providing one or more electronic updates.

In another aspect, the user interface includes a display ranking the one or more user profiles based on the value of the virtual currency amount maintained on the one or more user profiles.

In another aspect, the one or more processors are configured for integration with one or more statistical information databases and one or more publication databases, and the instructions further cause the one or more processors to: retrieve statistical information from the one or more statistical information databases related to one or more factors associated with human development, the one or more factors including at least one of economic factors, health factors, education factors, and environmental factors; retrieve publication information from the one or more publication databases; provide a user interface to the plurality of users, the user interface displaying at least (i) information associated with the one or more charitable organizations and (ii) information maintained in the one or more user profiles, and the user interface configured for receiving one or more crowd-sourced updates from the one or more users, the crowd-sourced updates indicative of (i) a severity level of an event, (ii) the location of the event, (iii) whether the event is beneficial or deleterious and (iv) a time indicative of when a crowd-sourced update was provided; using machine-reading techniques, automatically process the publication information to extract information indicative of (i) the severity level of an event, (ii) the location of the event, (iii) whether the event is beneficial or deleterious and (iv) a time indicative of when the publication was published; determine one or more numerical scores based on (i) the retrieved statistical information, (ii) the processed publication information and (iii) the one or more crowd-sourced updates, each of the one or more numerical scores associated with one or more regions and indicative of a level of need for charitable aid in the one or more regions; and provide the one or more numerical scores to the user interface.

In another aspect, the target charitable organization is automatically determined without user input using at least both (i) one or more numerical scores and (ii) the one or more indications of charitable giving preferences.

In another aspect, each factor of the one or more factors is associated with a weighting, and instructions further cause the one or more processors to: modify the weighting associated with each factor of the one or more factors based on the one or more indications of charitable giving preferences.

In another aspect, the instructions further cause the one or more processors to: generate one or more predictions based at least on the one or more user profiles; and wherein the target charitable organization is automatically determined without user input using at least (iii) the one or more generated predictions.

In another aspect, a computer-implemented method for administering the contribution of paid time off by a plurality of users to one or more charitable organizations on a system having: one or more processors configured for integration with one or more human resources systems, the one or more human resources systems maintaining electronic records associated with payroll information of the one or more users of the plurality of users, one or more data storage devices storing data, the data at least including one or more indications of charitable giving preferences associated with one or more users of the plurality of users and a non-transitory computer-readable memory in communication with the one or more processors and the one or more data storage devices is provided, the method comprising: generating one or more user profiles, each user profile associated with each user of the plurality of users; receiving one or more indications of charitable giving preferences associated the plurality of users; receiving one or more electronic requests from the plurality of users, the one or more electronic requests indicative of an intention to donate an amount of paid time off accrued by the plurality of users; validating the one or more electronic requests by communicating the one or more electronic requests to the one or more human resources systems and receiving a signal indicative of the validation status of the one or more electronic requests; if the one or more electronic requests are valid, processing the one or more electronic requests by (i) determining an approximate exchange value associated with a unit of time worked by the user associated with the electronic request based at least on the payroll information stored on the one or more human resources systems, (ii) determining a currency value associated with the amount of paid time off to be donated using at least the approximate exchange value, (iii) communicating to the one or more human resources systems an indication of the amount of paid time off that has been flagged for donation, and (iv) generating an electronic record indicative of an electronic credit equal to the currency value; receiving, from the one or more human resources systems, a first electronic payment of funds in an amount based at least on the determined currency value associated with the amount of paid time off to be donated; based at least on the one or more charitable giving preferences, determining a target charitable organization; and transmitting, to a computing system associated with the target charitable organization, a second electronic payment of funds in an amount based at least on the determined currency value associated with the amount of paid time off to be donated.

In another aspect, the method further comprises receiving an electronic indication representative of a third party entity's willingness to augment donations by the plurality of users; and wherein the second electronic payment of funds is in an amount based at least on (i) the amount of paid time off to be donated and (ii) the electronic indication representative of the third party entity's willingness to augment donations by the plurality of users.

In another aspect, the method further comprises providing a user interface to the plurality of users, the user interface displaying at least (i) information associated with the one or more charitable organizations and (ii) information maintained in the one or more user profiles.

In another aspect, the method further comprises maintaining, in each user profile of the one or more user profiles, a virtual currency amount having a value; and increasing the value of the virtual currency amount maintained on a user's profile when one or more electronic requests are successfully processed.

In another aspect, the method further comprises electronically tracking activities of one or more users of the plurality of users on the one or more user profiles; and increasing the value of the virtual currency amount maintained on a user's profile when the tracked activities are detected.

In another aspect, the tracked activities include at least one of (i) accessing the system, (ii) providing one or more electronic comments, (iii) providing one or more electronic reviews, and (iv) providing one or more electronic updates.

In another aspect, the user interface includes a display ranking the one or more user profiles based on the value of the virtual currency amount maintained on the one or more user profiles.

In another aspect, the one or more processors are configured for integration with one or more statistical information databases and one or more publication databases, and the method further comprises: retrieving statistical information from the one or more statistical information databases related to one or more factors associated with human development, the one or more factors including at least one of economic factors, health factors, education factors, and environmental factors; retrieving publication information from the one or more publication databases; providing a user interface to the plurality of users, the user interface displaying at least (i) information associated with the one or more charitable organizations and (ii) information maintained in the one or more user profiles, and the user interface configured for receiving one or more crowd-sourced updates from the one or more users, the crowd-sourced updates indicative of (i) a severity level of an event, (ii) the location of the event, (iii) whether the event is beneficial or deleterious and (iv) a time of when a crowd-sourced update was provided; using machine-reading techniques, automatically processing the publication information to extract information indicative of (i) the severity level of an event, (ii) the location of the event, (iii) whether the event is beneficial or deleterious and (iv) a time indicative of when the publication was published; determining one or more numerical scores based at least on (i) the retrieved statistical information, (ii) the processed publication information and (iii) the one or more crowd-sourced updates, each of the one or more numerical scores associated with one or more regions and indicative of a level of need for charitable aid in the one or more regions; and providing the one or more numerical scores to the user interface.

In another aspect, the target charitable organization is automatically determined without user input using at least both (i) one or more numerical scores and (ii) the one or more indications of charitable giving preferences.

In another aspect, each factor of the one or more factors is associated with a weighting, and the method further comprises: modifying the weighting associated with each factor of the one or more factors based on the one or more indications of charitable giving preferences.

In various further aspects, the disclosure provides corresponding systems and devices, and logic structures such as machine-executable coded instruction sets for implementing such systems, devices, and methods.

In this respect, before explaining at least one embodiment in detail, it is to be understood that embodiments are not limited in its application to the details of construction and to the arrangements of the components set forth in the following description or illustrated in the drawings. Embodiments are capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding, and are not intended as a definition of the limits of the disclosure.

Embodiments will now be described, by way of example only, with reference to the attached figures, wherein:

FIG. 1 provides a high-level schematic diagram of the system is provided, according to some embodiments.

FIG. 2A provides a high level schematic diagram of various components of a system, according to some embodiments.

FIG. 2B provides a high level schematic diagram of various components of a system configured to determine an altruism health index, according to some embodiments.

FIG. 3A provides a sample workflow depicting computer-implemented steps performed by the system in facilitating the contribution paid time off, according to some embodiments.

FIG. 3B provides a sample workflow depicting computer-implemented steps performed by the system in facilitating the contribution paid time off, illustrating example steps that may be performed by an analytics mechanism that may be useful in determining areas and/or regions that may be in distress and/or need, according to some embodiments.

FIG. 3C provides a sample workflow depicting computer-implemented steps performed by the system in facilitating the contribution paid time off, according to some embodiments.

FIG. 3D provides a sample workflow depicting computer-implemented steps performed by the system in facilitating the contribution paid time off, according to some embodiments.

FIG. 4 is an illustrative diagram providing a description of computer hardware and software that may be used in the implementation of certain aspects, as detailed in the description.

FIGS. 5-9 provide sample screenshots that further describe some aspects, according to some embodiments.

FIG. 10A-F provide illustration of an example data model, according to some embodiments. FIG. 10B is a sample quality of life index, ranked by country, FIG. 10C is a table of example world index information, FIG. 10D is a sample table of effects used to calculate various values, FIG. 10E is an example summary of fit graph, and FIG. 10F is an example expression of the data model of FIG. 10A, where an adjustment factor may be determined in relation to each variable, according to some embodiments.

### DETAILED DESCRIPTION

Embodiments of methods, systems, and apparatus suitable for use in implementing embodiments are described through reference to the drawings.

The following discussion provides many example embodiments of the subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

With respect to computer-implemented embodiments, the description provided may describe how one would modify a computer to implement the system or steps of a method. The specific problem being solved may be in the context of a computer-related problem, and the system may not be meant to be performed solely through manual means or as a series of manual steps.

Computer-related implementation and/or solutions may be advantageous in the context of some embodiments; at least for the reasons of providing scalability (the use of a single platform/system to manage a large number of activities); the ability to quickly and effectively pull together information from disparate networks; improved decision support and/or analytics that would otherwise be unfeasible; the ability to integrate with external systems whose only connection points are computer-implemented interfaces; the ability to achieve cost savings through automation; the ability to dynamically respond and consider updates in various contexts (such as the update of a contribution matching policy); the ability to apply complex logical rules that would be infeasible through manual means; the ability for donors to be truly anonymous; among others.

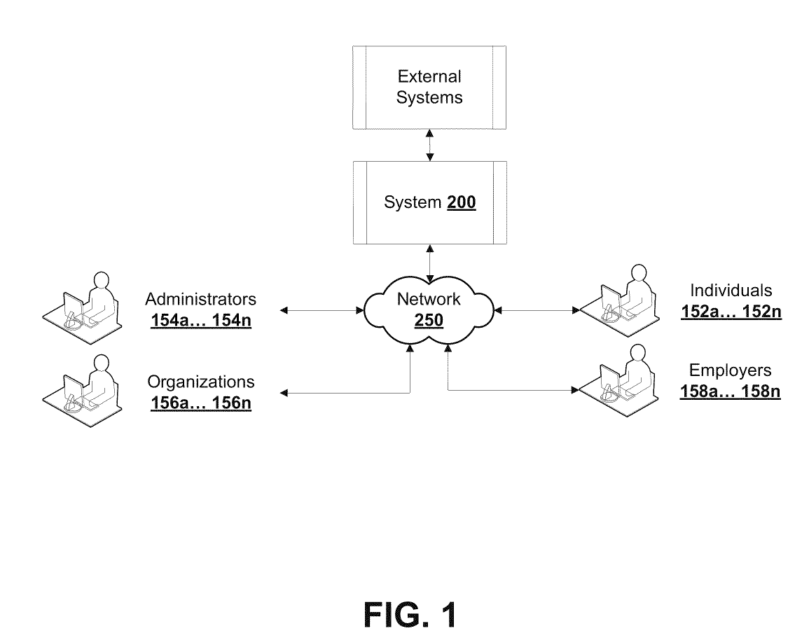

FIG. 1 provides a high-level schematic diagram of a system 200 for administering, tracking and/or managing paid time off, according to some embodiments.

The stakeholders may include one or more individuals 152a . . . 152n, one or more administrators 154a . . . 154n, one or more organizations 156a . . . 156n, one or more employers 158a . . . 158n. These stakeholders may interact with the system 200 in various capacities.

The one or more individuals 152a . . . 152n may include employees, contractors, or any type of person who has or can accumulate paid time off. The one or more administrators 154a . . . 154n may include various people who may be tasked with the operating and/or administration of the system 200, such as people who may be defining various business rules, defining integration with various external systems, etc. The one or more organizations 156a . . . 156n may include various organizations, and may be defined broadly to also include any organization involved in charitable activities, such as registered charities, non-profit organizations, non-governmental organizations, foundations, for-profit organizations, funding campaigns, trusts, cooperatives, incorporated entities, unincorporated entities, people conducting charitable activities, museums, associations, societies, partnerships, unions, institutes, think-tanks, campaigns, political campaigns, etc.

In some embodiments, the one or more organizations 156a . . . 156b may also include various alternative financing vehicles, such as crowdfunding, crowdsourcing, equity crowdfunding, etc., and these alternative financing vehicles may also have one or more campaigns and/or tiers of funding, etc. associated with the alternative financing vehicle. The one or more employers 158a . . . 158n may be broadly defined to include various organizations, businesses, contracting companies, subcontracting companies, corporations, partnerships, sole proprietorships, etc.

Paid time off may include various forms of policies wherein individuals, such as employees or contractors, may be paid during time that they may use for various reasons, such as sick leave, vacation, personal reasons, etc. Paid time off may include various periods of times, such as full days, half days, hours, minutes, seconds, etc. The paid time off may be set in the future, may be retroactive, and may, in some circumstances, be allocated and/or accumulated due to various reasons, such as in compensation for overtime, as part of an employment contract, as part of a service contract, etc.

The paid time off may be tracked using various means, such as non-electronic means and/or electronic means. Paid time off may be increasingly tracked and/or monitored using electronic means, as electronic means may provide a convenient and/or efficient way for organizations to track, apply, and/or monitor paid time off. For example, paid time off may be tracked in the form of electronic records, such as human resources records, which may be stored in as records in various forms and/or formats, such as spreadsheets, flat files, relational database records, non-relational database records, etc. These electronic records may be stored, for example, in various human resources computing systems and accessing through various application programming interfaces (APIs).

Paid time off may provide an opportunity to monetize assets. Paid time off may be provisioned based on employment/services contracts, and may accumulate over time in various accounts tracked, in some cases, by various human resources systems. For example, electronic records stored on or otherwise accessible to a system 200 may indicate that a person being tracked (e.g., an employee, a contractor, a student) has a certain amount of paid time off accrued to the person's account. In some embodiments, paid time off is accrued and generated based on the time that a person has worked. In some embodiments, paid time off expires after a period of time or upon a triggering event or conditions (e.g., the start of each fiscal year). Paid time off may also rollover into other years, and in some embodiments, a partial or limited rollover may be provided (e.g., only two weeks in a year may be rolled over).

The paid time off may be set to expire, depending on the policy details, and often accumulates. The accumulation of paid time off may be problematic for both individuals and employers: for individuals, the paid time off may be difficult to utilize for various reasons, such as family reasons and/or professional reasons; and for employers, the paid time off may exist on the balance sheets of the employer as a liability, potentially having distorting effects on reporting and/or taxation. In some cases, the paid time off simply expires without any financial benefit for the individual.

Using electronic and/or computerized means can provide a system 200 that may be more convenient, scalable, efficient, accurate, and/or reliable than traditional, non-computerized means. Further, many systems for tracking paid time off may be computerized and the platform may advantageously be designed for interoperability, and manual operation may be difficult and/or impossible. Scalability may be useful as it may be advantageous to provide a system 200 that may be able to effectively manage a large number of contributions and/or interconnections and/or integration with external systems. The effectiveness of a solution may be valuable in the context of contributions as individuals often do not prioritize their charitable activities in light of other activities. The convenience and ease of use may lead to higher contributions and/or more targeted contributions.

In some embodiments, the system 200 may be configured to integrate with various systems related to paid time off, such as time management, payroll services, human resources, etc., in assessing the amount of and/or valuating the paid time off for one or more individuals. This paid time off may be in the future or accumulated (e.g., accrued) paid time off. Paid time off can be tracked, for example, on electronic records, databases, files, etc., and in some embodiments, are accessible through interaction and/or communication with various APIs located on one or more human resources systems. For example, there may be electronic records that are associated with payroll information that may include information on aspects such as a rate per hour associated with the user (e.g., pay rate), tax burden associated with the user, a rate of accrual of paid time off, and/or a total amount of accrued paid time off. In some embodiments, there may be forecasted paid time off (e.g., for the upcoming fiscal year).

In some embodiments, the system 200 may be configured to integrate with various systems related to charitable giving and/or contributions for alternative funding models (such as crowdsourcing campaigns), such as tracking systems at a business, tracking systems at one or more organizations, etc. The integration with the various systems related to charitable giving/alternative funding models may be used for reporting, decision support, data analytics, etc. In some further embodiments, the system 200 may be configured to trigger matching contributions by various organizations and/or other donors (e.g., the employer or a major foundation has decided to provide matching contributions/donations). Other types of contributions incentives may also be considered.

In some embodiments, the system 200 may be configured to integrate with various financial systems, such as those at banks, financial institutions, clearinghouses, payment settlement companies, valuation companies, internal accounting systems, payroll services, etc. The integration with various financial systems may be utilized to perform financial transactions in respect of the value of the paid time off being contributed. In some further embodiments, the integration with various financial systems may be utilized to calculate and/or manage accounts related to taxation. For example, such integration may be utilized to enable payroll service integration that leads to automated donation processing. These financial systems may enable the transferring of various electronic funds payment, for example, electronic funds payments from employers (e.g., paid out when a user donates his/her paid time off), from third parties (e.g., when an entity wishes to match and/or otherwise augment a user's donation), to various organizations (e.g., paying out a charity when a donation is triggered), etc.

The transfers may be conducted electronically, through for example, a Society for Worldwide Interbank Financial Telecommunication (SWIFT) banking transaction, an automated clearing house, an e-commerce payment system, a digital currency (e.g., Bitcoins™), etc. Transfers may be conducted by transferring funds, sending payment orders (which may need to be settled by correspondent accounts), etc.

In some embodiments, the system 200 may be configured for the valuation of paid time off, which may be calculated based on various factors, such as the annual/weekly/biweekly salary of the individual, values from a pre-determined look up table, the age of the individual, etc. The valuation of paid time off may also be configured based on various matching and/or auxiliary funding that may be available, such as matching contributions by other donors, foundations, grants, etc. Such schemes may be useful for various reasons, such as incentivizing contributors who otherwise would not have contributed at all or such a large amount.

In some embodiments, the system 200 may be configured to generate, utilize and/or modify various data structures and/or data processing technology that may be useful in the contribution of paid time off.

In some embodiments, the system 200 may configured to integrate with one or more social media networking utilities for various social media related functionality, such as the posting and/or updating of one or more messages/media, the tracking of various contribution campaigns, the encouragement of other individuals to contribute, etc. The system 200 may be configured to apply various machine-reading and/or other types of machine-processing to automatically extract information out of social media postings. In some embodiments, the system 200 may be configured to apply various machine-reading and/or other types of machine-processing to automatically extract information out of media publications, for example, tracking information such as (i) the severity level of an event, (ii) the location of the event, (iii) whether the event is beneficial or deleterious and (iv) a time indicative of when the publication was published.

In some embodiments, the system 200 may be configured to initiate various reminders that may, in some scenarios, be initiated by an individual, or in other scenarios, initiated by the system. For example, the platform may be configured prior to the end of a fiscal year to remind individuals with accumulated paid time off that may be expiring that an option may be to contribute the remaining paid time off, and then provide an indication of the progress of campaigns related to the organization. Other types of reminders may occur when, for example, when the system, through the application of various rules and/or logic, may be configured to determine when/if an individual's paid time off may be reaching an accumulation limit.

For example, if company policy indicates that an individual may only maintain a balance of 20 days of paid time off, if an individual may be reaching that and/or exceeding that policy-based limit, in some embodiments, the individual may be notified of the same and encouraged to contribute. In some further embodiments, the notification may also be configured to calculate the potential tax benefits of such a contribution and/or provide decision support in relation to the tax benefits that may arise from contributing paid time off that may be not be usable otherwise (e.g., John Smith is reaching an accumulation limit of paid time off and may benefit from a contribution of 1 day of paid time off, with a tax savings of $50, which he otherwise would not have been able to accumulate due to company policies on total accumulated paid time off).

In some embodiments, the system 200 may be configured to provide one or more data analytics tools to provide various functionality related to reporting and/or providing views on one or more factors associated with the contribution of paid time off. In further embodiments, the platform may be configured to develop reporting based on demographics, and/or provide data mining capabilities that may be used to extract various information about the contribution of paid time off, such as the determination of various relationships and variables. For example, the platform may be configured to determine whether the rate of contributions may be seasonal, cyclic, bonus-driven, event driven, social media driven, etc.

In some embodiments, the system 200 may be configured to provide one or more decision support tools that may be used by an individual choosing which organization/campaign to contribute his/her paid time off to, or may be used by an administrator to help develop the strategic elements of conducting a campaign to attract more individuals to contribute paid time off. For example, the decision support tools may indicate that higher than average contributions of paid time off occurs around Christmas, and that the campaign should target individuals with incomes between a particular range. As an example of providing decision support to individuals, the platform may help an individual decide which charity to contribute to, based on various criteria, such as relationship to employer, relevance to the individual's contribution objectives, proportion of contributions used for charitable activities as opposed to administration, recent activity and/or campaigns by the charity, etc. Other considerations may also include potential matching by other donors, employers, foundations, etc., and/or an altruism health index, as described below.

In some embodiments, the platform may be configured to establish, update and/or access one or more metrics (an “altruism health index”) wherein an aggregate score is generated in relation to various charitable and/or organization objectives. The breadth of the one or more metrics may vary.

In some embodiments, the altruism health index may be a single score that indicates how well society is doing as whole in regards to the sum of global impact, taking into account positive impacts and deleterious impacts (e.g., a metric aggregated based on various factors, such as, but not limited to, the number of people suffering in the world, a score representing the amount of injustice in the world, the number of capable people in the world, how many of the capable people are helping the problem, what people are doing to solve problems, the effectiveness of various actions, the impact of advocacy for a cause). The altruism health index may be calculated in various ways using various algorithms, such as using a weighted score, or any other means.

In some embodiments, the altruism health index may be a set of values associated with one or more charities, one or more organizations, one or more alternative financing campaigns, one or more charitable campaigns, etc., and may be associated with how effective they are at carrying out a particular mandate, or their general effectiveness. The altruism health index may be based on various factors, such as the measured social impact of their campaigns, adherence to leading practices, amount of contributions spent on administration costs, impact of campaigns relative to funding, board composition and/or independence, reviews, external data, etc. The altruism health index may be received from external sources and/or developed and/or updated through the internal database. In some embodiments, the altruism health index may be provided to various stakeholders in providing decision support elements during their use of the system.

The information used to generate the altruism health index may be obtained from various external sources (e.g., government data, censuses, data from non-governmental organizations, economic statistics, disease burdens, GDP statistics, infection rates, crime data, data from charities), and/or obtained from tracking various information internally by the system. The information may be grouped into a number of factors and associated with a weighting.

The altruism health index may, for instance, be utilized by the system in helping encourage certain behaviors, provide decision support to users, indicate for a user which social issues may be more open to impactful contributions, indicate for a user the value of his/her advocacy, etc.

The altruism health index may, in some embodiments, be a normalized score to indicate and/or estimate a severity level associated with various regions (e.g., identifying and/or estimating which of the most desperate global regions in dire need of aid.

The score may also be tracked over a period of time and may accordingly change. Each score may be associated with a particular region or area.

The altruism health index may also be segregated by region, and the system may be configured such that a user is able to view, at various levels of granularity, the altruism health index at, for example, a global level, a regional level, by sub-group, by charity, by social issue, etc. A data-driven interface may be provided, and the interface may be configured to provide various electronic indications and/or conduct various determinations.

For example, a data driven user interface may be provided to educate users and/or identify targets (e.g., automatically, or based on various rules) associated with areas and/or regions having a need for resources and/or aid (e.g., the most appropriate, most desolate places around the globe). The contributions that are made on the platform may be tracked over time, with impact normalized and improvement tracked. In some further embodiments, the altruism health index can also integrate with user analytics to understand a user's preference and make donation decisions, recommendations and/or even make a recurring donation for a user with specified preferences. For example, a target charitable organization may be automatically determined without user input using at least both one or more numerical scores from the altruism health index and the user's indications of charitable giving preferences.

In some embodiments, an automated donation system is provided wherein based on a user's specified preferences, recurring donations may be targeted based, at least in part, on a determined altruism health index score. Accordingly, a system may be provided such that a user may be able to set a donation (e.g., of the user's paid time off) and preferences.

The system may be configured to, in an automated fashion, (a) receive this information from the user by interfacing with one or more human resources systems to extract payroll information; (b) determine the value of the donation (e.g., interface with the user's payroll system to receive user information) and/or determine any matching In some embodiments, the system 200 may support the generation, usage and/or trading of virtual credits (e.g., “philanthropoints”). The virtual credits may be held on the system and utilized at a future time to indicate that a contribution may be applied for a particular campaign. The virtual credits may be generated and/or awarded for various reasons, such as rewarding individuals for a contribution of paid time off (or other currency), or advocacy (e.g., providing postings, publishing articles, writing comments, reviewing organizations, using hashtags, uploading media such as photos, audio and/or video) that leads to contributions and/or other value. Such credits being potentially applicable for future charitable giving. In some further embodiments, the virtual credits may be exchanged for various goods and/or services, or may connote a particular status to a particular individual (e.g., John Smith has contributed a very large proportion of his paid time off. Please consider his example and contribute generously). Data collected, tracked, and activities may be utilized in promoting and/or providing a reward system. The system 200 may be configured may utilize, for example, electronic information stored in various databases and/or user profiles having regard to user activities, donation activities, activity on the system 200, etc.

The virtual currency and/or credit system may provide various aspects of engagement, such as gamification (e.g., credits can be utilized to promote various forms of activity), competition (e.g., a leaderboard), etc. In some embodiments, the virtual currency and/or credit system may be associated with donation matching (e.g., by other donors/corporations/organizations).

In some embodiments, the virtual credits may be utilized to trade with external organizations in regards to goods and/or services that they may offer, and/or access to various promotions (e.g., John Smith has contributed a very large portion of his paid time off and was awarded with 10 units of virtual currency. Travel firm, an organizational sponsor, wishes to reward John and may accept 10 units of virtual currency in exchange for providing a discounted trip to Bermuda for John and his family). The virtual currency may be awarded for various other activities, such as providing information, filling our surveys, submitting reviews, gamification activities, advocacy activities (e.g., advocacy on social media), etc. For example, virtual credits may also be given for liking events on a social media website, friend referrals, recommending a charitable campaign. The virtual credits may also be calculated in various ways, such as through the impact of a contribution in contrast to the actual amount contributed. As an example, a numeric ranking may be assigned to each charity based on its perceived impact, and virtual credits may be provided based on a calculation of the total impact of a particular contribution.

In some embodiments, the system 200 may be configured to support review functionality in respect of various charitable and/or alternative funding campaigns and/or organizations. For example, a stakeholder may be able to provide a rating and/or a comment in regards to his/her experience with a particular campaign and/or organization. The system 200 may, in some embodiments, aggregate this information and/or present a consolidated/expandable view to various stakeholders.

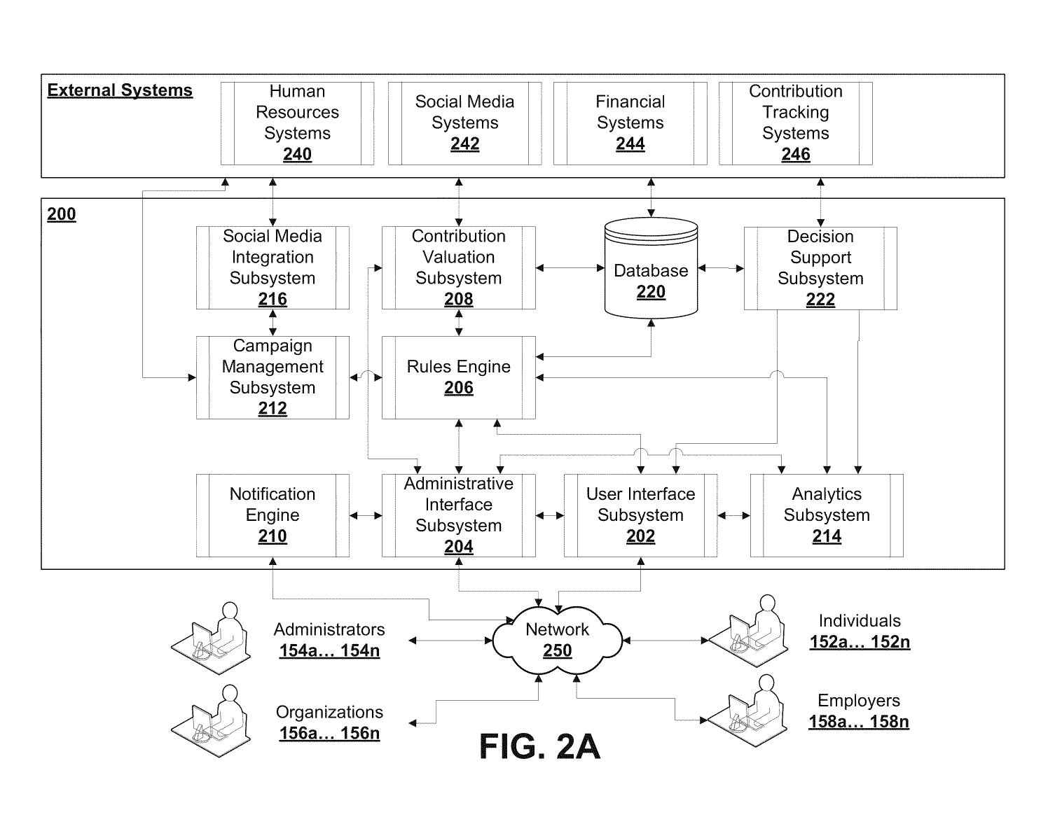

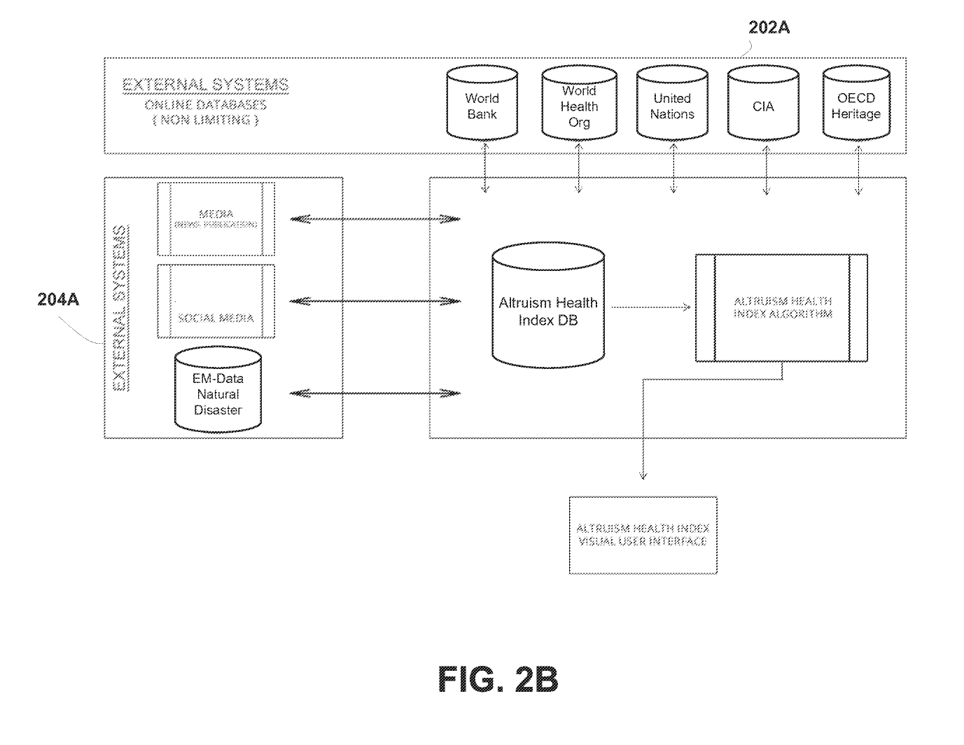

FIG. 2A provides a high level schematic diagram of various components of a system 200, according to some embodiments. The system may be configured to provide a platform that may be configured to enable and/or manage the contribution of paid time off.

System 200 may include various units, such as a user interface unit 202, an administrative interface unit 204, a rules engine 206, a contribution management unit 206, a contribution valuation unit 208, a notification engine 210, a campaign management unit 212, an analytics engine 214, a social media integration unit 216, a payment engine 218, a database 220, and a decision support unit 222.

The various units may be implemented through various electronic and/or computer-implemented means, such as in software and/or in hardware. The units may be instructions performed by one or more processors, at one or more servers. The database 220 may be a non-transitory computer readable medium.

The system 200 may include one or more servers having one or more processors, operating in conjunction with one or more computer-readable storage media, configured to provide backend services, such as data processing, data storage, data backup, data hosting, among others.

The system 200 may also integrate with one or more external systems, such as human resources systems 240, social media systems 242, financial systems 244, contribution tracking systems 246.

Human resources systems 240 may include payroll systems, human resource management systems, etc. Social media systems 242 may include external social networking platforms, such as Facebook, LinkedIn, Twitter, MySpace, etc. Financial systems 244 may include banks, financial institutions, clearinghouses, payment settlement companies, valuation companies, internal accounting systems, etc. Contribution tracking systems 246 may include any external tracking systems, such as those used by charities or organizations to manage their charitable campaigns, crowdsourcing campaigns, donor management systems, fundraising systems, grant tracking systems, etc.

Interfaces with the external systems may, for example, include an application programming interface (API) that may provide communications means between various machines. An API may be implemented via various technologies, such as Simple Object Access Protocol (SOAP), interfaces developing through exposing functionality using programming code, representational state transfer (REST) adhering programming techniques, etc.

For example, integration may be conducted through a plug-in with various human resources management systems, time keeping systems, active directory systems, etc. Integration with payroll and/or other human resources system APIs may be used to automate various tasks (e.g., updating accounting). These tasks can include the aggregate of dollars donated by employees, companies in a specified time range. Further automated functionality can be automated money transfers to complete transactions between entities. In some embodiments, the integration of donation activities may be conducted on a per-transaction basis. In some embodiments, integration of donation activities may be conducted on in bulk on a periodic basis. In some embodiments, the tasks may include integration with various units configured to determine tax liabilities and/or tax credits associated with philanthropic activities. Donation matching may also be conducted.

The system 200 may also operate through and/or using one or more networks 250. The one or more networks 250 may include the internet, intranets, point to point networks, etc. Networking technology may include technologies such as TCP/IP, UDP, WAP, etc.

The user interface unit 202 may be configured to provide an interface for individuals 152a . . . 152n to interact with the system 200. The user interface unit 202 may be, for example, a web portal, a mobile application, a mobile portal, a desktop application, an API, etc.

The user interface unit 202 may further be configured for access through one or more social media networks. For example, the system 200 may be configured such that the platform may be accessible through a plugin at a social media website.

The user interface unit 202 may provide various functionality to the individuals 152a . . . 152n, which may include the ability to view the amount of paid time off is available for contribution, the ability to view the amount of future paid time off expected, the ability to view the amount of paid time off is accumulated, the ability to designate paid time off for contribution, the ability to view the valuation of paid time off, the ability to set the valuation of the paid time off, the ability to select which organizations the paid time off should be allocated to, the ability to request receipts, the ability to view logs or analytics regarding historical contributions, the ability to share messages about the contribution of paid time off, the ability to request recommendations on organizations, the ability to view the contributions of others, the ability to contribute anonymously, the ability to contribute money and/or other types of assets alongside paid time off, etc.

In some embodiments, the user interface unit 202 may be configured to allow an individual to view/track the impact of their contribution. Such functionality may be potentially useful in helping ‘close the loop’ in contributions. Such tracking may be conducted through the viewing of analytics, signing up for notifications, the provisioning of personal messages, the provisioning of various media, etc. For example, information may be displayed showing information associated with the one or more charitable organizations and information maintained in user profiles. In some embodiments, an amount of virtual currency may also be indicated. There may be rankings, etc., associated with the amount of virtual currency held by different users.

In some embodiments, the user interface unit 202 may be configured to support the hosting of various media to be played to the individuals 152a . . . 152n, such as photographs, pictures, audio files, video files, interactive media, etc.

In some embodiments, the user interface unit 202 may be configured to interact with the notification engine 210 to send notifications to one or more individuals 152a . . . 152n.

In some embodiments, the user interface unit 202 may be configured to generate/associate/update one or more user profiles for each of the one or more individuals 152a . . . 152n who may be using the system 200.

In some embodiments, the user interface unit 202 may be configured to generate one or more physical vouchers (e.g., paper vouchers), denoting various aspects related to donated paid time off (e.g., a name, a value, a number of hours) and associating the physical voucher with a redemption code. The redemption code, in some embodiments, may be a computer generated code (e.g., a unique or near-unique code) that may be utilized to unlock and/or initiate a transfer of funds to a particular recipient charity. For example, the physical vouchers may be provided through devices such as kiosks, or mailed to the user. In some embodiments, the physical vouchers may be configured to be printed by the user. The administrative interface unit 204 may be configured to provide various functionality to administrators 154a . . . 154n, such as the ability to define rules, modify rules, add/remove/modify organizations, add/remove/modify specific campaigns, add/remove/modify various descriptions, view/run reports, download data, etc. This functionality may also be provided to other types of users who may require administrative access, such as organizations 156a . . . 156n and employers 158a . . . 158n.

In some embodiments, the administrative interface unit 204 may be configured to interact with the notification engine 210 to send notifications to one or more administrators 154a . . . 154n.

In some embodiments, the administrative interface unit 204 may be configured to provide various views, such as a dashboard, to administrators 154a . . . 154n, indicating, for example, the progress of various charitable/contribution objectives, aggregate statistics for various organizations, reporting based on data analytics, etc.

The rules engine 206 may be configured for the generation of rules, the modification of rules and/or the application of rules. The rules may be broadly defined as logical connections that may be defined to cause various actions to occur based on the fulfillment of one or more criteria. For example, a rule may be set that may be triggered upon the occurrence of a particular event, or the lack of occurrence of a particular event. These rules may be used for various purposes by the system 200, such as the definition of relationships between various charitable campaigns, the conversion of paid time off to monetary contribution amounts, the generation of notifications based on particular triggers, initiating matching contributions, determining whether an individual 152a . . . 152n has enough paid time off to make their desired contribution, etc. The rules may be programmatically defined and may contain one or more triggers and may cause the execution of various actions by one or more units. For example, rules may be set out in relation to virtual currency, and set out to increase the value of the virtual currency amount maintained on a user's profile when one or more electronic requests for donating paid time off are successfully processed. Similarly, the system may be configured for electronically tracking activities of one or more users of the plurality of users on the one or more user profiles; and increasing the value of the virtual currency amount maintained on a user's profile when the tracked activities are detected (e.g., log in, social media posting, posting reviews, updating a profile).

In some embodiments, the rules engine 206 may be configured to develop rules related to the processing of payments and/or settlement of accounts with various external systems. For example, the rules engine 206 may have rules defined for the synchronous, asynchronous, and/or batch settlement of contribution transactions. For example, all the contributions of paid time off for organization A may have a rule in place indicating that all transactions may be uploaded in a batch basis scheduled at the end of every week. Similarly, there may be a converse rule indicating that a particular charity should be provided an aggregate payment at the end of every month.

The contribution valuation unit 208 may be configured to determine the value of an individual 152a . . . 152n's paid time off. For example, if an individual wished to contribute two hours of time to a particular charity, the contribution valuation unit could determine how much would be paid out to that charity. The contribution valuation unit 208 may utilize various methods and/or techniques to determine the valuation, such as, but not limited to, multiplying the number of hours by a predetermined value for the hours based on the individual's pay rate per hour; considering the amount of potential matching by a third party, such as an employer or a foundation; the amount set forth by a look up table (e.g., an hour of an engineer's time is worth XX, an hour of a physician's time is worth YY), etc.

In some embodiments, the contribution valuation unit 208 may also be configured to communicate with human resource systems such as payroll systems, employee records, etc. to determine the value of the paid time off. Various matching programs may be considered in developing the valuation of a particular contribution, and may be determined through the application of various rules, etc.

The notification engine 210 may be configured to provide one or more notifications to various stakeholders, such as individuals, administrators, organizations, employers, etc. The notification engine 210 may be configured to utilize communications means such as text messages, phone calls, emails, social media messages, etc. The notification engine 210 may interoperate with the rules engine 206 to communicate notifications based upon one or more rules. Various notifications can be provided related to communications to/from various organizations to stakeholders, such as notifications indicating the particular impact of a contribution and/or where it benefitted (e.g., five months after a contribution, a user may be alerted that their contribution contributed to the building of a school's main foyer).

The campaign management unit 212 may be configured to maintain a listing of organizations, alternative funding organizations, their campaigns, contribution targets, their tiers/rewards, etc.

In some embodiments, the campaign management unit 212 may also be configured to interoperate with the rules engine 206 to provide logical rules around the charitable campaigns, such as how long the campaign is operating for, whether any notifications should be triggered for a campaign, etc.

In some embodiments, the campaign management unit 212 may be further configured to help provide decision and analytics support by keeping track of various information related to the one or more organizations/campaigns. For example, the historical amount of paid time off could be maintained in a database, information regarding the organization's latest activities, etc.

The analytics engine 214 may be configured to provide various functionality related to reporting and/or analytics. The analytics engine 214 may interoperate with other units and/or engines in providing inputs and/or outputs based on analysis conducted on aggregate data, such as data from the database 220.

The analytics engine 214 may be configured such that some or all interactions with end-users, be they potential contributors, donors, charities, partners, client company employees, administrators or anybody else may be captured through instrumentation means.

The instrumentation means could include data capture means for generating characterizing recordable events for: web based interactions, interactions via apps, text interactions, voice interactions or interactions generated at any other human user to system touch-point.

The data capture instrumentation may capture discrete interactions events wherever they are considered to offer the potential to provide insight into user behavior, system usability, system failures, performance metrics, usage rates of particular pieces of functionality, general management reporting requirements, and/or support predictive analysis and insight into intent, future interests, or any other aspect of future user or system action that could lead to a more efficient experience by employing such prediction. The events may be captured and/or characterized with a date/time stamp as well as attributes that are considered to characterize those events.

The analytics engine 214 may be configured to enable the definition and control of those characterizing attributes such that the utility of such events for the purposes mentioned above may be most fully realized. The analytics engine 214 may may include a means to characterize users by permitting the creation of summary attributes or elements at individual user level (often known by marketers in this summary form as the “profile” of an individual) or at user segment level, in ways that characterize and differentiate users or user groups. The analytics engine 214 may maintain an updated view of such profile elements, be that in real time as events occur, or periodically (such as once per hour or once per day) in an offline updating mode.

The analytics engine 214 may be configured to include predictive modelling capabilities that uses transformed historical events, profiles and outcomes configured in a way that permits predictive models to be generated and users and user-contexts to be scored. The purpose of such a predictive capability being the generation of validated recommendations, optimized content, and/or otherwise personalized interface configurations for system users to increase the efficiency and value of the system to those users. One or more predictions made by the analytics engine 214 may be computed in real time, based on a fully updated user profile, or offline with some delay as required by the particular application. The predictive capability of the analytics engine 214 may include the means to triage potential candidate actions based on the calculated respective merit of those actions, using predictive models, such that the candidate action predicted to deliver the greatest benefit can be taken.

The analytics engine 214 may be configured to interoperate with the user interface unit 202 to provide support for social discovery, helping users connect with causes that most likely would impact and/or have the most relevance to their particular social/charitable goals. In some embodiments, the analytics engine 214 may provide functionality to rank and/or benchmark users, coworkers, friends, family, etc. Various organizations such as charities and/or alternative funding sources may be able to use the analytics engine 214 to determine various information, such as their contribution totals, average contribution amount, etc.

In some embodiments, the analytics engine 214 may be configured to provide customized reporting, such as reports that help identify that 23% of users within 3 minutes of looking at their specific social media posting or tweet or video, contribute an average of $55, or that within 10 minutes of looking at a charity's profile page, they contribute to another charity, etc. In some embodiments, the information generated from the analytics engine 214 may also be used to mine various data elements from the data set in the database 220, for example, to analyze and understand that John's general time for contributing is November, John is partial to animals, John's friends are also interested in animal welfare, John donates yearly, and John is in the San Francisco area. With this data, the system may be configured to automatically present John with an opportunity to contribute to the humane society of San Francisco in November. The analytics engine 214 may also be potentially useful in providing functionality to companies/employers to identify their employees' passions and causes, etc. In John's example, the system may suggest a donation at a local humane society in San Francisco, the American Society for the Prevention of Cruelty to Animals (ASPCA), etc., and the analytics engine 214 may also be configured to calculate a probability of donation (e.g., >95%). In such an example, the outcome may be an automatic donation or a suggested donation, John may be able to share his good deed with his friends, etc.

Data may be collected from various sources, such as the user's profile (e.g., email address, IP address, login locations, tracked cookie information), social networks (e.g., for friends, connections, relationships, stored information), human resources systems (e.g., salary, pay rate per hour, number of hours worked, position title), etc. For example, Sariu may be from India, Sariu may have friends and family in India, who are banana farmers, and he may be a mid-level manager at a software company in Silicon Valley. Sariu may make $175K a year in salary. There may be various aspects of modelling that may be combined with data about a particular user, such as climate, weather data, etc., and this modelled information may be utilized to determine which other users would be interested, and/or utilized to issue notifications in relation to a particular cause, organization and/or campaign. For example, a period of prolonged drought may be identified, the period of prolonged drought triggering the issuing of notifications to users who are may have a predictive score greater than a particular threshold to donate to a particular cause.

The analytics engine 214 may be configured to issue and/or generate various suggestions to issue donations, and in some embodiments, the predictive features may be utilized to help drive actions.

In some embodiments, the analytics engine 214 may be configured to provide functionality in relation to an analytics mechanism (“the altruism health index”) which may be utilized for various purposes, such as for social discovery, helping users connect with causes, etc. The analytics mechanism may yield various types of outputs such as a ranking, a numerical score, various sets of sub-scores, etc. These outputs may be provided in relation to specific countries, regions, etc., and further tailored analysis may be provided in relation to specific types of analyses that an individual wishes to consider or, in some embodiments, may be automated or semi-automated based on known information about an individual (e.g., information tracked about the individual in a profile, stored on cookies, past donation history). FIG. 2B provides a high level schematic diagram of various components of a system configured to determine an altruism health index, according to some embodiments. Various statistical databases are indicated at 202A and media/social media and crowdsourced information sources are indicated at 204A.

The social media integration unit 216 may be configured for integration with one or more social media platforms, such as Facebook, LinkedIn, Twitter, MySpace, etc. In some embodiments, social media integration unit 216 may also integrate with these platforms to provide functionality such as the ability to access contacts related to an individual, to initiate postings, to send messages, etc. An individual may have the ability to invite one or more contacts to utilize the platform or to also contribute their paid time off.

The payment engine 218 may be configured to provide integration with one or more financial institutions to conduct transactions where paid time off is contributed to permit an organization (e.g., a charity or a crowdfunding campaign) to receive the equivalent amount in actual money. For example, an individual working at a bank contributes 1 hour of paid time off to a charity. The system 200 may be configured to receive the request to contribute paid time off, value the paid time off based on a set of rules, and then proceed to pay an actual $50 to the charity.

In some embodiments, the payment engine 218 may be configured to operate using one or more different currencies.

In some embodiments, the payment engine 218 may also be configured to reconcile with various external systems the amount of paid time off removed, and in further embodiments, may also be configured to determine pre and post-tax amounts and/or tax holdbacks that may be of relevance to the transaction.

The database 220 may implemented using various database technologies, such as relational databases (e.g., SQL databases), flat databases, excel spreadsheets, comma separated values, etc. If the database 220 is implemented using relational database technology, the database 220 may be configured to further store relationships between various data records. The database 220 may be implemented using various hardware of software technologies, such as solid state or hard disk drives, redundant arrays of independent disks, cloud storage, virtual storage devices, etc.

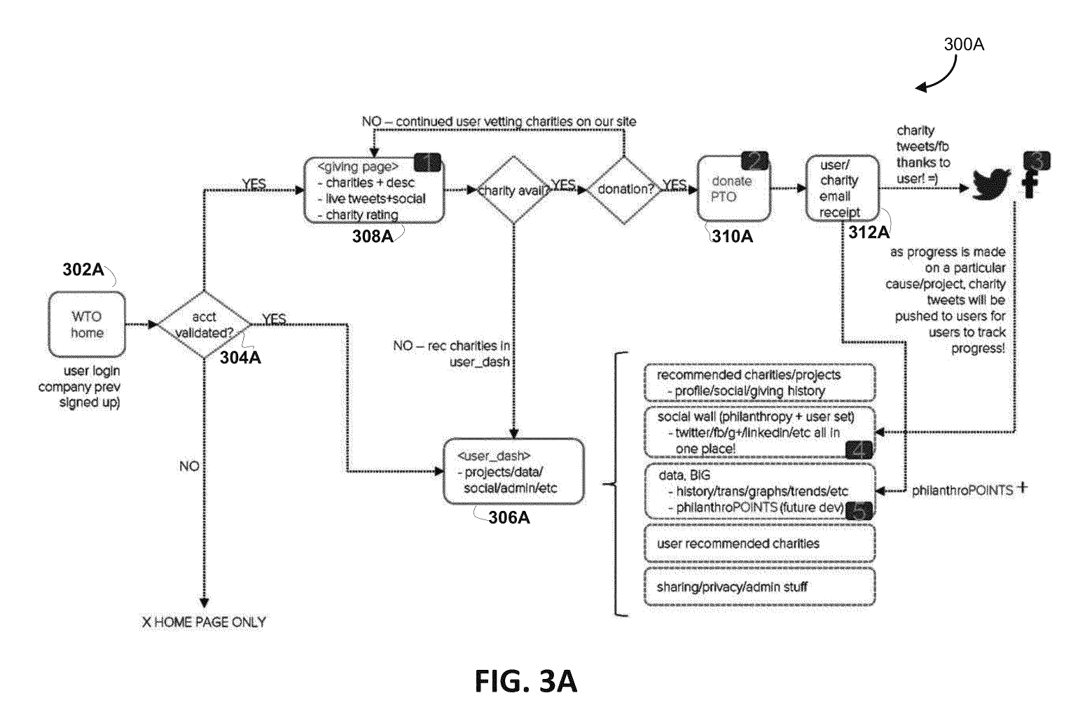

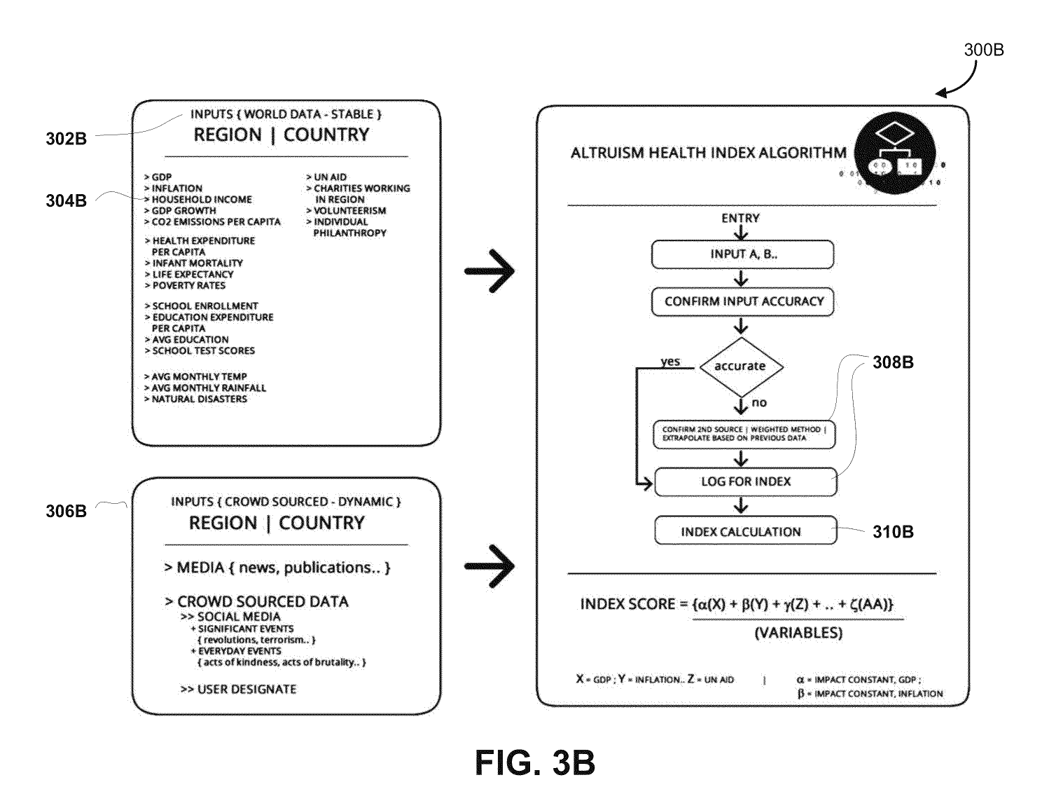

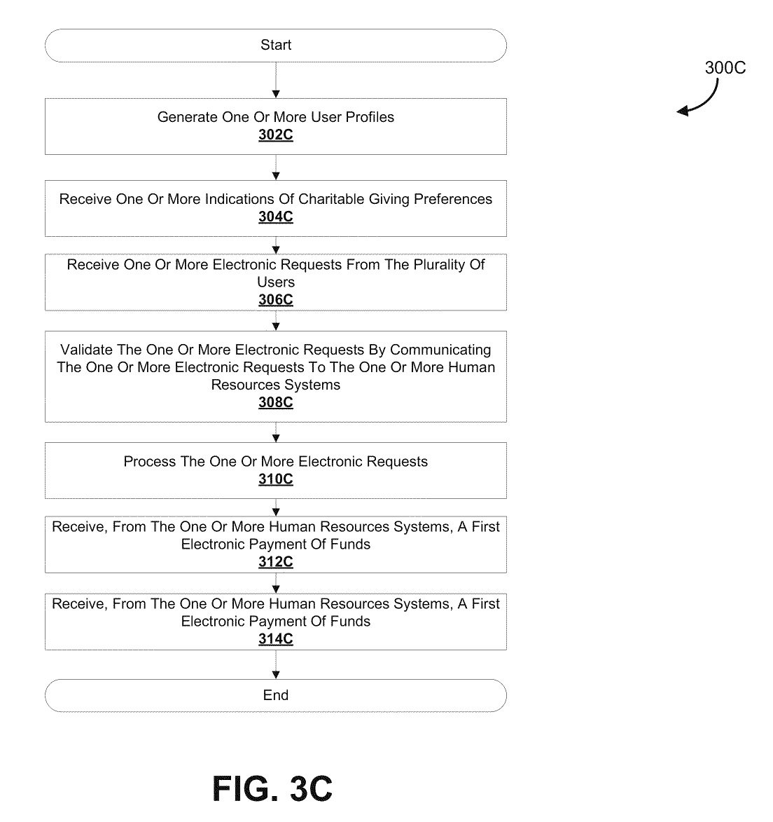

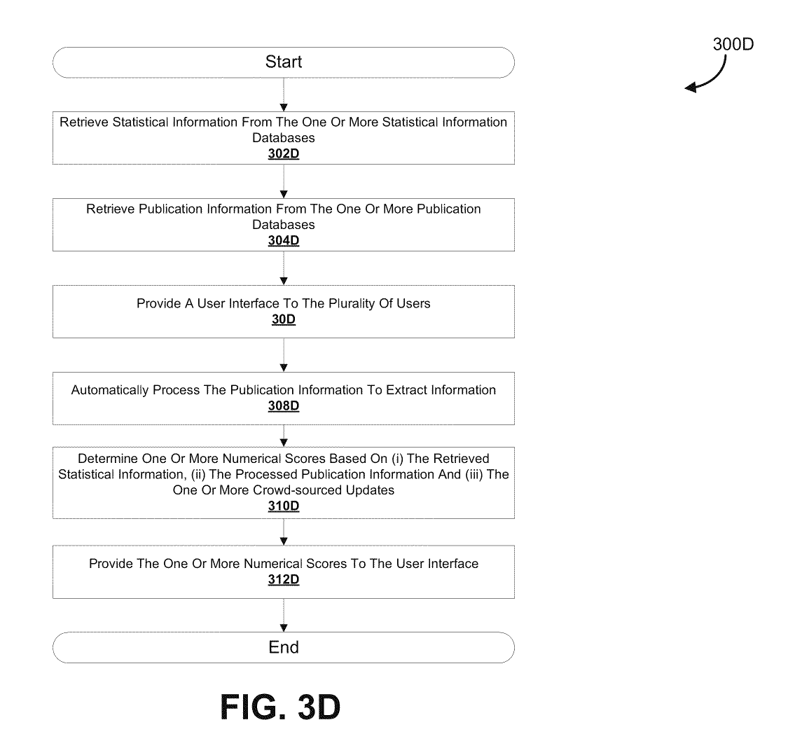

FIG. 3A provides a sample workflow 300A depicting computer-implemented steps performed by the system in facilitating the contribution paid time off, according to some embodiments.

At step 302A, the individual accesses the user interface unit 202, which, in some embodiments, validates the user's profile under step 304A.

At step 306A, the user may view a dashboard that may show various elements of information, such as charitable projects, historical data about campaigns/the individuals usage, recent occurrences related to social media, and may also conduct various administrative tasks associated with his/her profile (password resets, etc.).

At step 308A, the individual may be able to initiate a contribution through a page that provides a listing of various information, which may include organizations, campaigns, descriptions, social media elements, ratings of organizations, etc. At this step, there may also be a recommendation from the decision support unit 222 that may recommend one or more organizations depending on various criteria, such as alignment with the individual's stated charitable objectives. In some embodiments, potential matching contributions by a third party, such as an employer or a foundation, may also be depicted to help the individual decide how much paid time off to contribute.

At step 310A, upon selecting a campaign and providing an amount of paid time off to be contributed, the system 200 may be configured to generate and execute a transaction whereby the contribution of paid time off may be communicated to one or more external human resources systems, the paid time off may be given a valuation by the contribution valuation unit 208, and the payment engine 218 may provision a payment to the designated charity.

At step 312A, a receipt may be generated by the campaign management unit 212 to various systems/people, such as to the individual who contributed, their employer, the charity, the alternative funding organization, the funded company, various foundations, various financial institutions, etc. In some embodiments, the social media integration unit 216 may be triggered to provide various postings and/or messages about the contribution.

FIG. 3B provides a sample workflow 300B depicting computer-implemented steps performed by the system in facilitating the contribution paid time off, illustrating example steps that may be performed by an analytics mechanism that may be useful in determining areas and/or regions that may be in distress and/or need, according to some embodiments. At step 302B, the analytics engine 214 is configured to interoperate with various electronic resources, such as the World Bank's databases, the United Nations' databases, the World Health Organization's databases, the Central Intelligence Agency's databases, and/or the Organization for Economic Co-operation and Development's databases. Various real and non-real-time data are retrieved from these sources. This data is stored in database 220.

At step 304B, the analytics engine 214 is configured to process the received data based on various factors, such as economic factors (e.g., gross domestic product, growth, inflation, household, income); health (e.g., health expenditure per capita, infant mortality, life expectancy, poverty rates); education (e.g., school enrollment, education expenditure per capita, average level of education, test scores); environmental (e.g., average monthly temperature, average monthly rainfall, natural disasters); external information (e.g., united nations aid charities working in region, volunteerism individual philanthropy); and/or corruption. This processed data may be utilized as a basis for various determinations, such as the analytics mechanism that may be useful in determining areas and/or regions that may be in distress and/or need, quantifying charity impact and effectiveness, calculation of virtual currencies, etc.

At step 306B, aspects from various external sources, such as social media, short term dynamic data (e.g., media, publications) and/or crowd sourced sources (e.g., crowd-sourced and/or user input descriptions and/or reviews of significant events such as revolutions, terrorism, and everyday events such as acts of kindness, generosity movements, among others), are further processed in conjunction with the data received from online database sources. For example, information stored on United Nations and/or World Bank databases may be static and/or updated on a regular basis, while crowd funded and/or short term dynamic data may be updated on a more regular basis (or real/near real time). In some embodiments, information from publication and/or news sources may be automatically inferred based on machine learning and/or computer learning algorithms used to parse the information. In some embodiments, information from crowd sourced sources may include reviews from users of the system 200. Greater/lesser weights may be applied for reviews and/or comments from users who have/do not have an identified track record of accuracy or a proxy thereof (e.g., based on previous activity), and similarly, there may be various rules applied to determine the weighting associated with information that may be corroborated and/or similar to those provided by other sources. For example, where there are multiple reviewers providing comments about a same or similar event, it may be more likely that the event has taken place and has had a particular impact.

At step 308B, various statistical modeling techniques may be applied, for example, using various algorithms, to process the combined information and/or data. Statistical modeling may include, for example, generating best fit models, adding degrees of freedom, functions of single or multiple orders, etc. Through this or other variation of data modeling, an accurate calculation can be made for each variable's impact within the altruism health index. Degrees of freedom may be utilized in determining, for example, an accuracy and/or a computational complexity associated with a determination.

The modeling techniques may include various normalization aspects, for example, applying various weights to various factors. Different weights may be applied to different factor as to determine a relative value as the factor relates to an outcome as a whole. For example, the amount of volunteerism would be weighed lower than education expenditure which in turn is weighed lower than infant mortality. For example, a sample equation may include:

$$INDEX SCORE = \frac{\{ α ( X ) + β ( Y ) + γ ( Z ) + … + ζ ( AA ) \}}{( VARIABLES )}$$

$$\begin{matrix}X = GDP ; Y = INFLATION … \\ Z = UN AID\end{matrix} \vert \begin{matrix}α = IMPACT CONSTANT , GDP : \\ β = IMPACT CONSTANT , \\ INFLATION\end{matrix}$$

At step 310B, the information is utilized to present a specific index (e.g., a numerical score) that is provided on a region-by-region basis (e.g., by country) and may be indicative of an inferred “distress level” associated with that region.

For example: each country or region with data available may have an associated score (e.g., Sierra Leone>>Altruism Health Index Score 2.3 Turkey>>Altruism Health Index Score 5.5 United States>>Altruism Health Index Score 7.5 Germany>>Altruism Health Index Score 8.9).

In some embodiments, an index may be calculated only using a particular subset of the data (e.g., if a user is seeking to generate an index value based only on healthcare concerns). In such an embodiment, the weightings may be dynamically altered and/or re-weighted to reflect prioritization. For example, a user may be interested in providing and/or donating paid time off to charities having a larger than average impact in regions of greater distress, but is most interested in donating in the infant healthcare space.

This data may be presented in various ways by user interface unit 202 to users (e.g., in a world map along with a “call to action” to support nonprofits that work in the region and/or field). In some embodiments, the system 200 may be configured such that a user does not need to select which organization to donate to, but rather, the system 200 automatically determines a specific organization to donate to based on the user's preferences in relation to factors such as interest areas, regions preferred, distress levels of regions, and/or minimum organization performance levels.

In some embodiments, the index is provided through a suitably configured API to various external sources such that the external sources are able to process and/or utilize the index.

FIG. 3C provides a sample workflow 300C depicting computer-implemented steps performed by the system in facilitating the contribution paid time off, according to some embodiments.

At step 302C, the system may be configured to generate one or more user profiles, each user profile associated with each user of the plurality of users.

At step 304C, the system may be configured to receive one or more indications of charitable giving preferences associated the plurality of users.

At step 306C, the system may be configured to receive one or more electronic requests from the plurality of users, the one or more electronic requests indicative of an intention to donate an amount of paid time off accrued by the plurality of users.

At step 308C, the system may be configured to validate the one or more electronic requests by communicating the one or more electronic requests to the one or more human resources systems and receiving a signal indicative of the validation status of the one or more electronic requests.

At step 310C, the system may be configured to, if the one or more electronic requests are valid, process the one or more electronic requests by (i) determining an approximate exchange value associated with a unit of time worked by the user associated with the electronic request based at least on the payroll information stored on the one or more human resources systems, (ii) determining a currency value associated with the amount of paid time off to be donated using at least the approximate exchange value, (iii) communicating to the one or more human resources systems an indication of the amount of paid time off that has been flagged for donation, and (iv) generating an electronic record indicative of an electronic credit equal to the currency value.

At step 312C, the system may be configured to receive, from the one or more human resources systems, a first electronic payment of funds in an amount based at least on the determined currency value associated with the amount of paid time off to be donated.

At step 314C, the system may be configured to, based at least on the one or more charitable giving preferences, determine a target charitable organization; and transmit, to a computing system associated with the target charitable organization, a second electronic payment of funds in an amount based at least on the determined currency value associated with the amount of paid time off to be donated.

FIG. 3D provides a sample workflow 300D depicting computer-implemented steps performed by the system in facilitating the contribution paid time off, according to some embodiments.

At step 302D, the system is configured to retrieve statistical information from the one or more statistical information databases related to one or more factors associated with human development, the one or more factors including at least one of economic factors, health factors, education factors, and environmental factors;

At step 304D, the system is configured to retrieve publication information from the one or more publication databases;

At step 306D, the system is configured to provide a user interface to the plurality of users, the user interface displaying at least (i) information associated with the one or more charitable organizations and (ii) information maintained in the one or more user profiles, and the user interface configured for receiving one or more crowd-sourced updates from the one or more users, the crowd-sourced updates indicative of (i) a severity level of an event, (ii) the location of the event, (iii) whether the event is beneficial or deleterious and (iv) a time indicative of when a crowd-sourced update was provided;

At step 308D, the system is configured to, using machine-reading techniques, automatically process the publication information to extract information indicative of (i) the severity level of an event, (ii) the location of the event, (iii) whether the event is beneficial or deleterious and (iv) a time indicative of when the publication was published;

At step 310D, the system is configured to determine one or more numerical scores based on (i) the retrieved statistical information, (ii) the processed publication information and (iii) the one or more crowd-sourced updates, each of the one or more numerical scores associated with one or more regions and indicative of a level of need for charitable aid in the one or more regions; and at step 312D, the system is configured to provide the one or more numerical scores to the user interface.

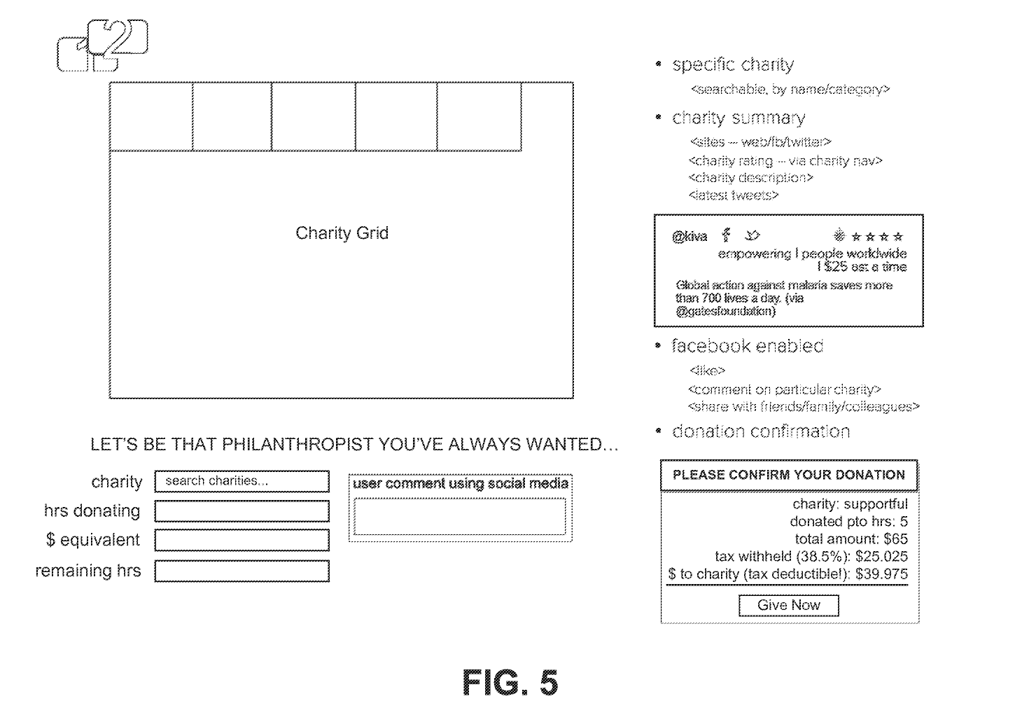

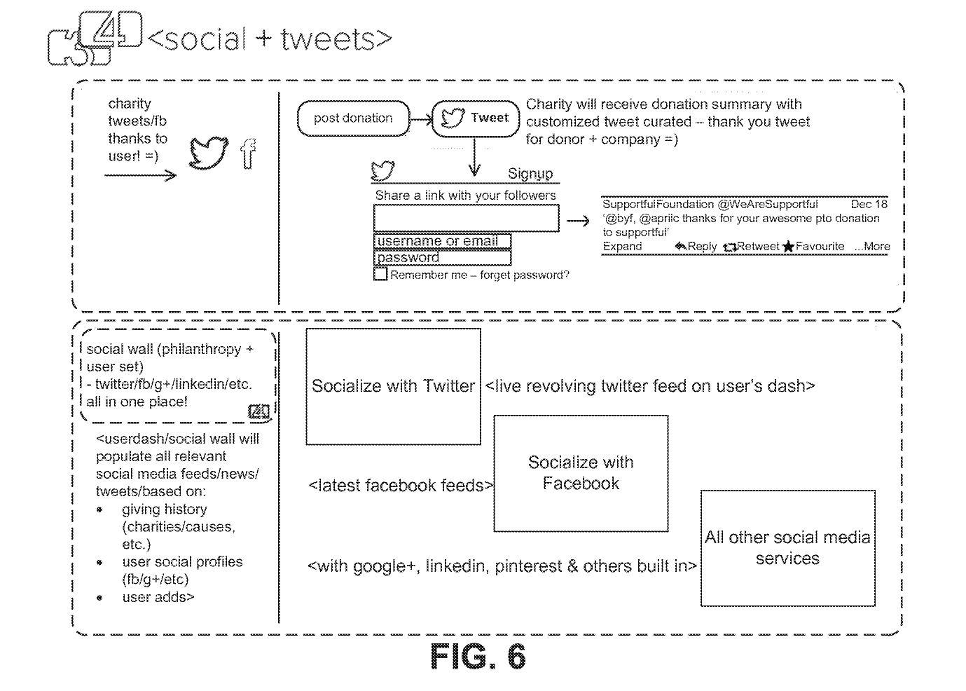

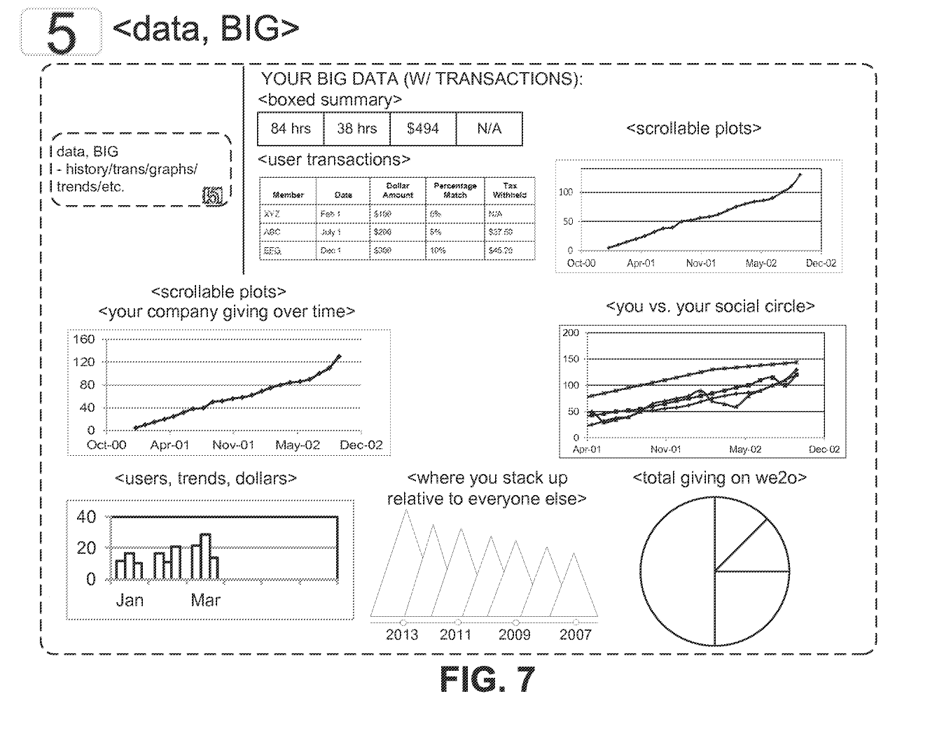

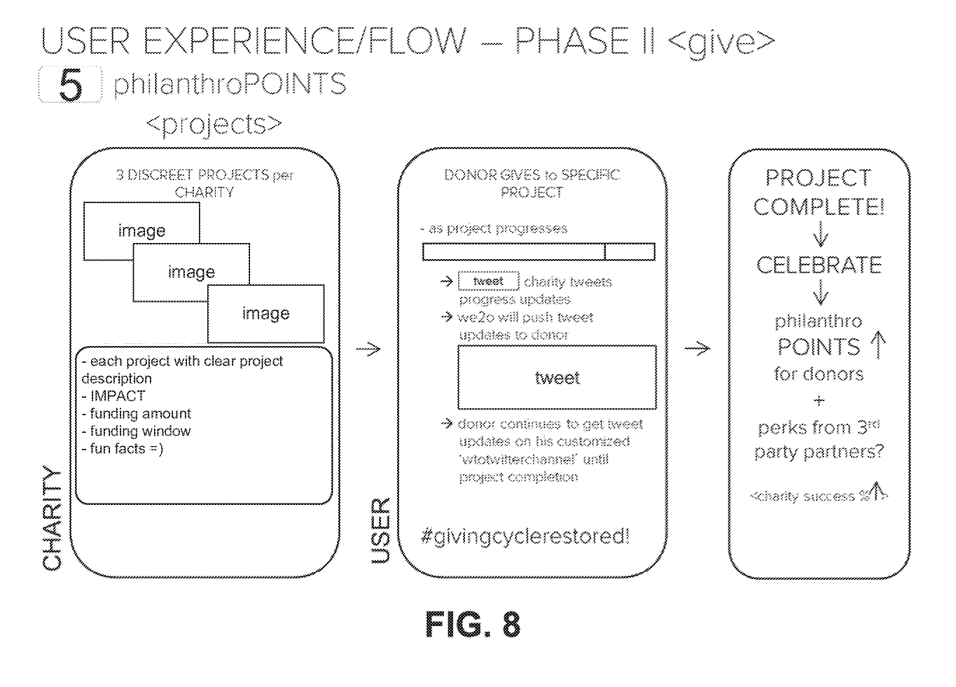

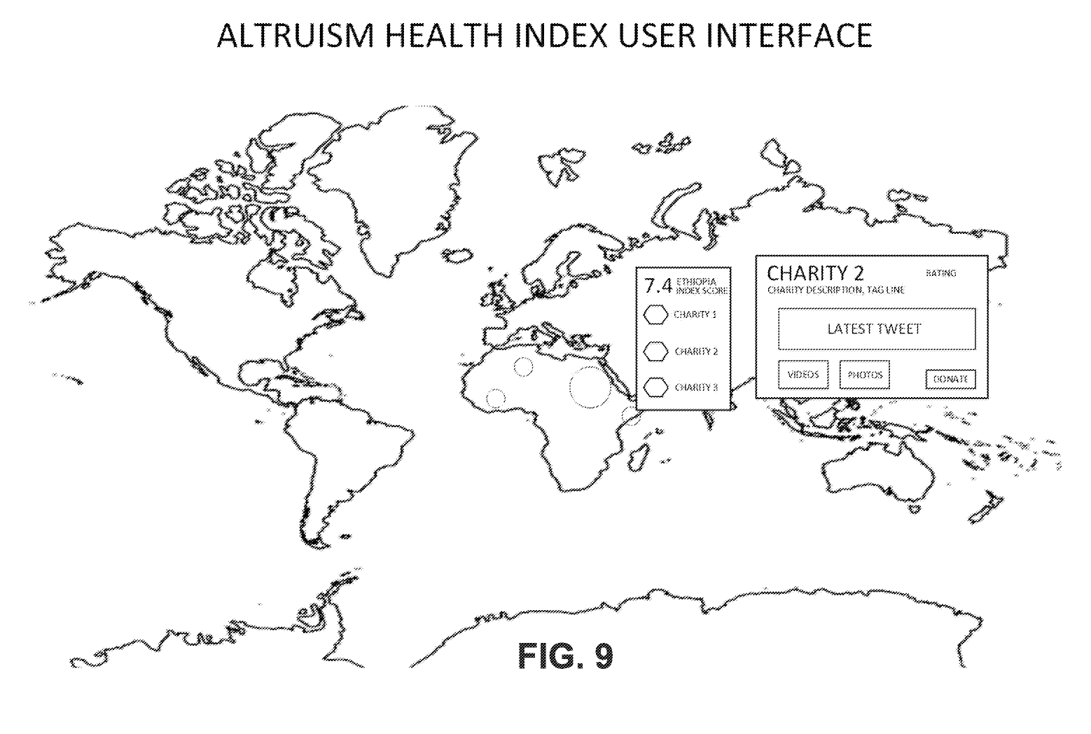

FIGS. 5-9 provide sample screenshots that further describe some aspects, according to some embodiments.

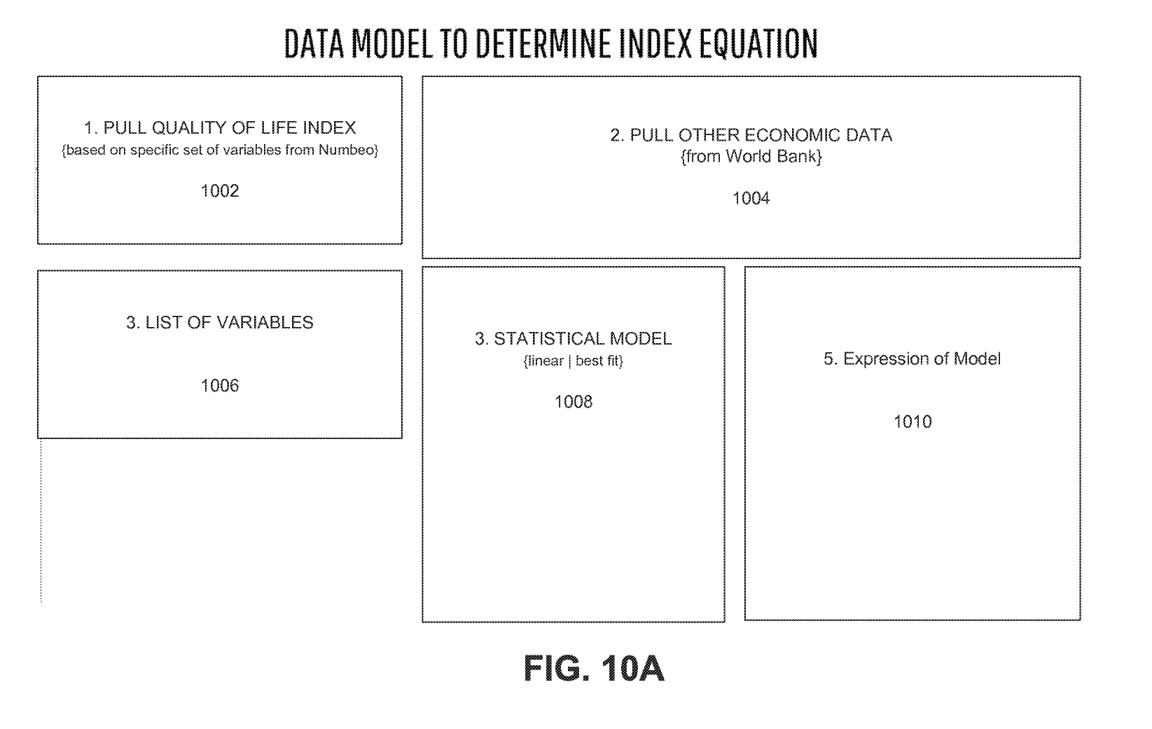

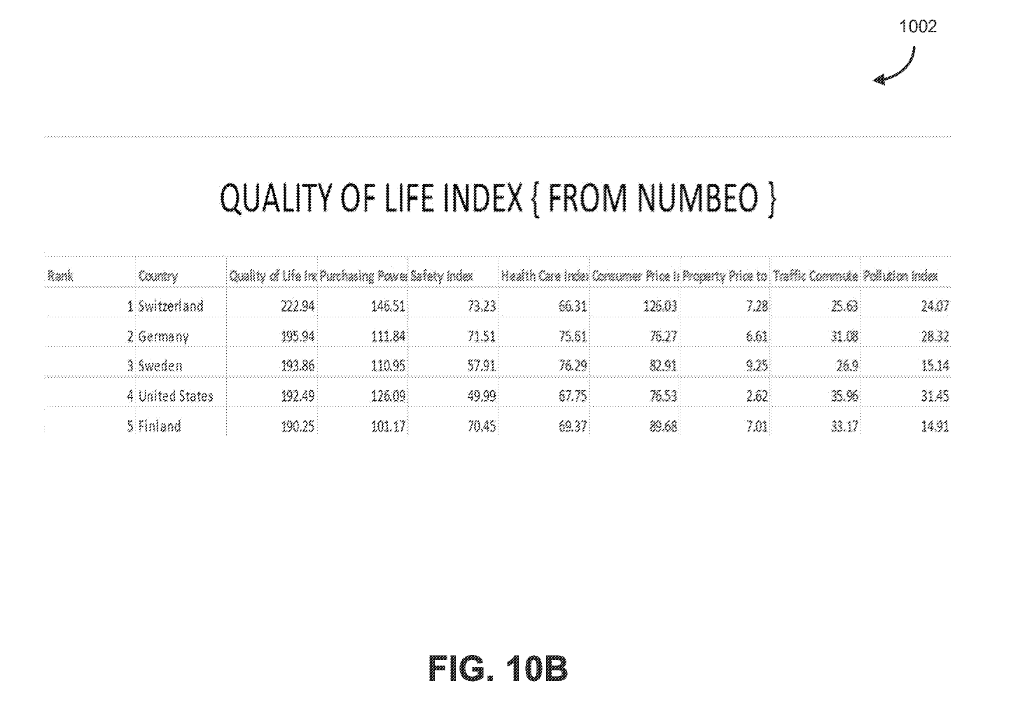

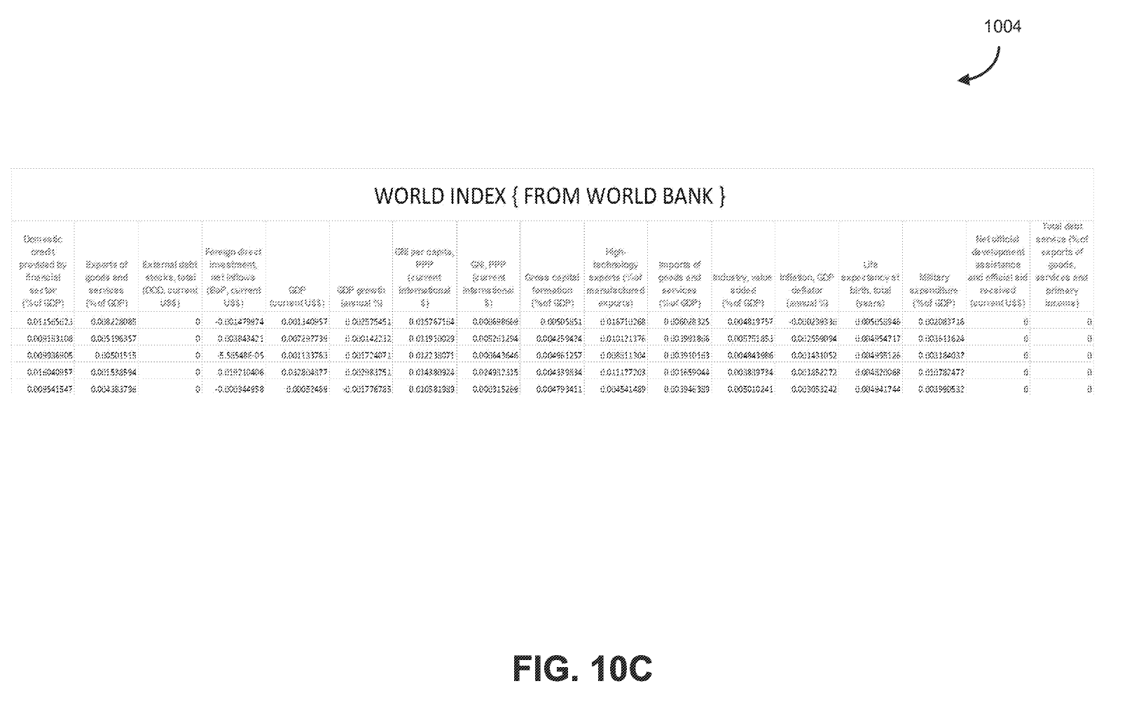

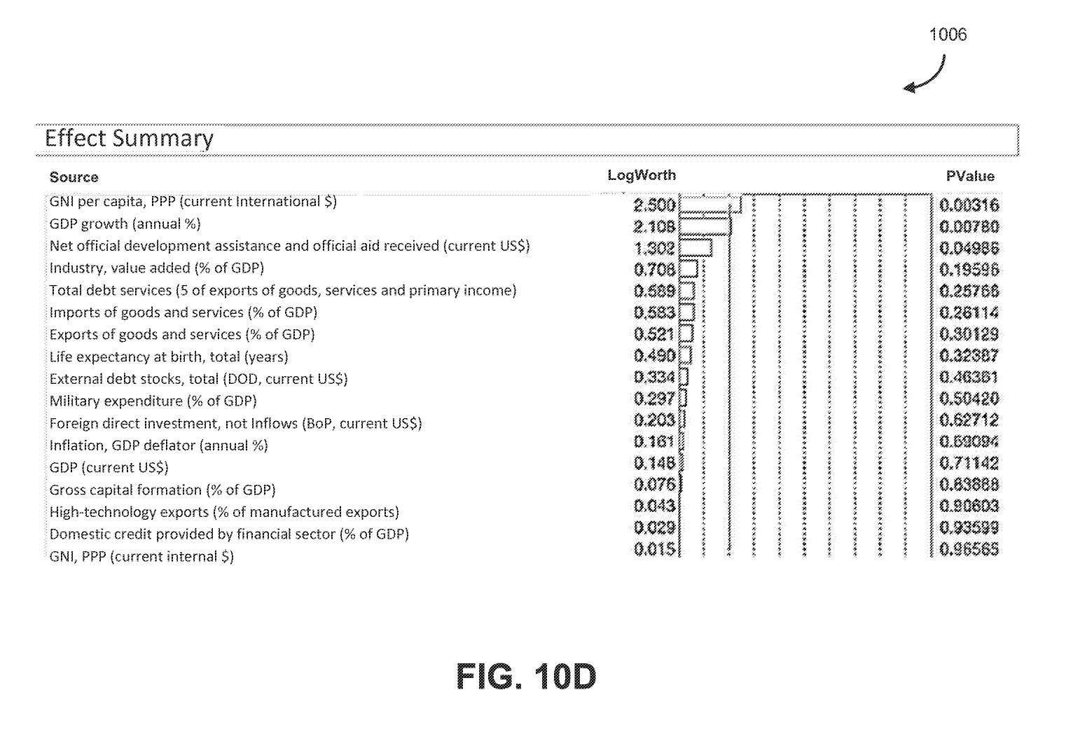

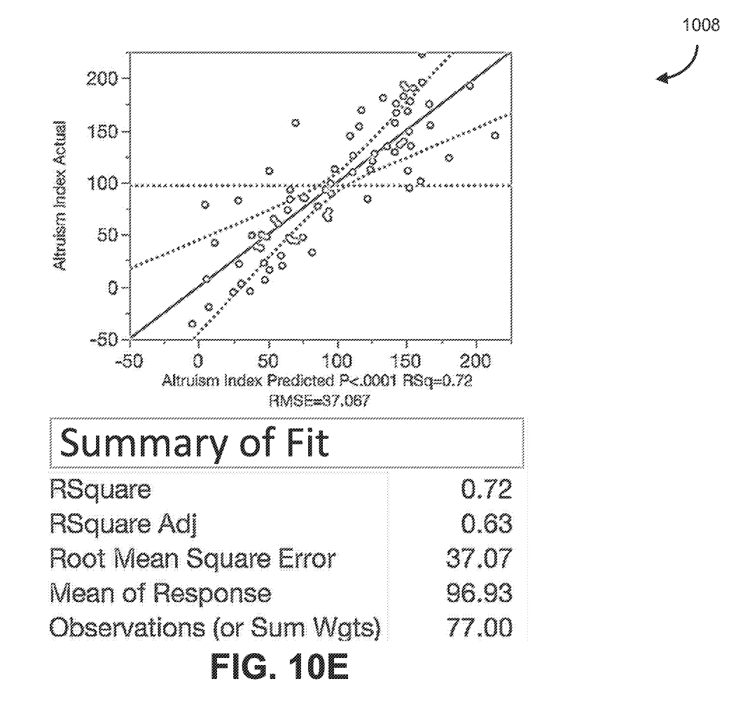

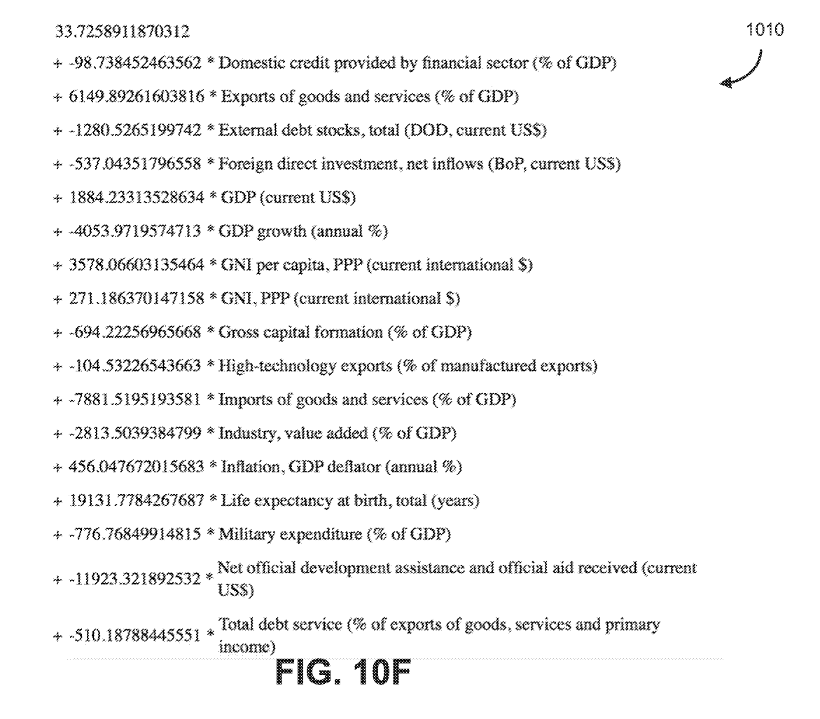

FIG. 10A-E is an illustration of an example data model, according to some embodiments, FIG. 10A is an illustration of the overall data model, and FIGS. 10B-10E provide sample tables and information that may be provided as part of the data model of FIG. 10A. As indicated in FIG. 10A, there may be components of the model indicated as 1002, 1004, 1006, 1008, and 1010.

In particular, FIG. 10B is a sample quality of life index 1002, ranked by country,

FIG. 10C is a table of example world index information 1004,

FIG. 10D is a sample table of effects 1006 used to calculate various values,

FIG. 10E is an example summary of fit graph 1008.

FIG. 10F is an example expression of the data model of FIG. 10A, where adjustment factors 1010 may be determined in relation to each variable, according to some embodiments.

### General

It will be appreciated by those skilled in the art that other variations of the embodiments described herein may also be practiced without departing from the scope of the disclosure. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances.

There may be various potential optimization and enhancements that may be practiced in regards to some embodiments. It should be understood that the description is provided as non-limiting, illustrative examples only. For example, there may be additions, omissions, modifications, and other implementations may be considered.

In some embodiments, the system 200 or some of its units may be implemented through a set of distributed computing devices connected through a communications network. An example of such a set of distributed computing devices would be what is typically known as a ‘cloud computing’ implementation. In such a network, a plurality of connected devices operate together to provide services through the use of their shared resources.

A cloud-based implementation may provide one or more advantages including: openness, flexibility, and extendibility; manageable centrally; reliability; scalability; being optimized for computing resources; having an ability to aggregate information across a number of users; and ability to connect across a number of users and find matching sub-groups of interest. While embodiments and implementations of the present disclosure may be discussed in particular non-limiting examples with respect to use of the cloud to implement aspects of the system platform, a local server, a single remote server, a software as a service platform, or any other computing device may be used instead of the cloud.

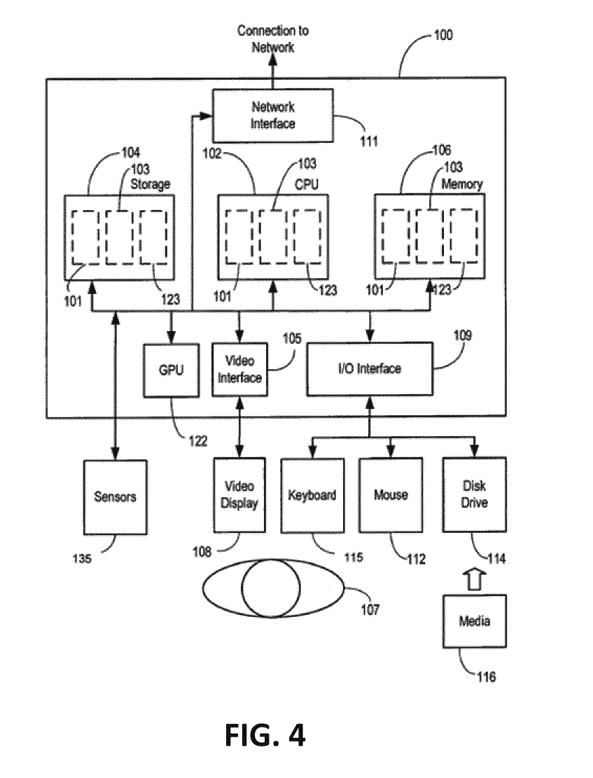

The present system and method may be practiced in various embodiments. A suitably configured computer device, and associated communications networks, devices, software and firmware may provide a platform for enabling one or more embodiments as described above. By way of example, FIG. 4 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on computer devices, including a desktop computer, laptop computer, tablet computer or wireless handheld. The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation. It is understood that the terms computer-readable medium or computer useable medium comprises one or more physical embodiments of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to mobile platforms, including the iOS™ platform, ANDROID™, WINDOWS™ or BLACKBERRY™.

It will be appreciated by those skilled in the art that other variations of the embodiments described herein may also be practiced. Other modifications are therefore possible.

What is claimed is:

1. A computer-implemented system for administering the contribution of paid time off by a plurality of users to one or more charitable organizations, the system comprising:
one or more processors configured for integration with one or more human resources systems, the one or more human resources systems maintaining electronic records associated with payroll information of the one or more users of the plurality of users;
one or more data storage devices for storing data, the data at least including one or more indications of charitable giving preferences associated with one or more users of the plurality of users;
a non-transitory computer-readable memory in communication with the one or more processors and the one or more data storage devices, the non-transitory computer-readable memory storing instructions, the instructions which when executed by the one or more processors, cause the one or more processors to:
generate one or more user profiles, each user profile associated with each user of the plurality of users;
receive one or more indications of charitable giving preferences associated the plurality of users;
receive one or more electronic requests from the plurality of users, the one or more electronic requests indicative of an intention to donate an amount of paid time off accrued by the plurality of users;
validate the one or more electronic requests by communicating the one or more electronic requests to the one or more human resources systems and receiving a signal indicative of the validation status of the one or more electronic requests;
if the one or more electronic requests are valid, process the one or more electronic requests by (i) determining an approximate exchange value associated with a unit of time worked by the user associated with the electronic request based at least on the payroll information stored on the one or more human resources systems, (ii) determining a currency value associated with the amount of paid time off to be donated using at least the approximate exchange value, (iii) communicating to the one or more human resources systems an indication of the amount of paid time off that has been flagged for donation, and (iv) generating an electronic record indicative of an electronic credit equal to the currency value;
receive, from the one or more human resources systems, a first electronic payment of funds in an amount based at least on the determined currency value associated with the amount of paid time off to be donated;
based at least on the one or more charitable giving preferences, determine a target charitable organization; and
transmit, to a computing system associated with the target charitable organization, a second electronic payment of funds in an amount based at least on the determined currency value associated with the amount of paid time off to be donated.

2. The computer-implemented system of claim 1, wherein the instructions further cause the one or more processors to:
generate a physical voucher based on the electronic record indicative of the electronic credit, the physical voucher denoting (i) at least the determined currency value associated with the amount of paid time off to be donated and (ii) a redemption code; and
wherein the second electronic payment of funds is conditioned on receiving the redemption code from the computing system associated with the target charitable organization.

3. The computer-implemented system of claim 1, wherein the instructions further cause the one or more processors to:
receive an electronic indication representative of a third party entity's willingness to augment donations by the plurality of users; and
wherein the second electronic payment of funds is in an amount based at least on (i) the amount of paid time off to be donated and (ii) the electronic indication representative of the third party entity's willingness to augment donations by the plurality of users.

4. The computer-implemented system of claim 1, wherein the instructions further cause the one or more processors to:
provide a user interface to the plurality of users, the user interface displaying at least (i) information associated with the one or more charitable organizations and (ii) information maintained in the one or more user profiles.

5. The computer-implemented system of claim 3, wherein the instructions further cause the one or more processors to:
maintain, in each user profile of the one or more user profiles, a virtual currency amount having a value;
electronically track activities of one or more users of the plurality of users on the one or more user profiles; and
increase the value of the virtual currency amount maintained on a user's profile when one or more electronic requests are successfully processed or when the activities are detected.

6. The computer-implemented system of claim 5, wherein the activities include at least one of (i) accessing the system, (ii) providing one or more electronic comments, (iii) providing one or more electronic reviews, and (iv) providing one or more electronic updates.

7. The computer-implemented system of claim 4, wherein the user interface includes a display ranking the one or more user profiles based on the value of the virtual currency amount maintained on the one or more user profiles.

8. The computer-implemented system of claim 1, wherein the one or more processors are configured for integration with one or more statistical information databases and one or more publication databases, and the instructions further cause the one or more processors to:
retrieve statistical information from the one or more statistical information databases related to one or more factors associated with human development, the one or more factors including at least one of economic factors, health factors, education factors, and environmental factors;
retrieve publication information from the one or more publication databases;
provide a user interface to the plurality of users, the user interface displaying at least (i) information associated with the one or more charitable organizations and (ii) information maintained in the one or more user profiles, and the user interface configured for receiving one or more crowd-sourced updates from the one or more users, the crowd-sourced updates indicative of (i) a severity level of an event, (ii) the location of the event, (iii) whether the event is beneficial or deleterious and (iv) a time indicative of when a crowd-sourced update was provided;
using machine-reading techniques, automatically process the publication information to extract information indicative of (i) the severity level of an event, (ii) the location of the event, (iii) whether the event is beneficial or deleterious and (iv) a time indicative of when the publication was published;
determine one or more numerical scores based on (i) the retrieved statistical information, (ii) the processed publication information and (iii) the one or more crowd-sourced updates, each of the one or more numerical scores associated with one or more regions and indicative of a level of need for charitable aid in the one or more regions; and
provide the one or more numerical scores to the user interface.

9. The computer-implemented system of claim 8, wherein the target charitable organization is automatically determined without user input using at least both (i) one or more numerical scores and (ii) the one or more indications of charitable giving preferences.

10. The computer-implemented system of claim 9, wherein the instructions further cause the one or more processors to:
generate one or more predictions based at least on the one or more user profiles; and
wherein the target charitable organization is automatically determined without user input using at least (iii) the one or more generated predictions.

11. A computer-implemented method for administering the contribution of paid time off by a plurality of users to one or more charitable organizations on a system having one or more processors configured for integration with one or more human resources systems, the one or more human resources systems maintaining electronic records associated with payroll information of the one or more users of the plurality of users, one or more data storage devices for storing data, the data at least including one or more indications of charitable giving preferences associated with one or more users of the plurality of users and a non-transitory computer-readable memory in communication with the one or more processors and the one or more data storage devices, the method comprising:
generating one or more user profiles, each user profile associated with each user of the plurality of users;
receiving one or more indications of charitable giving preferences associated the plurality of users;
receiving one or more electronic requests from the plurality of users, the one or more electronic requests indicative of an intention to donate an amount of paid time off accrued by the plurality of users;
validating the one or more electronic requests by communicating the one or more electronic requests to the one or more human resources systems and receiving a signal indicative of the validation status of the one or more electronic requests;
if the one or more electronic requests are valid, processing the one or more electronic requests by (i) determining an approximate exchange value associated with a unit of time worked by the user associated with the electronic request based at least on the payroll information stored on the one or more human resources systems, (ii) determining a currency value associated with the amount of paid time off to be donated using at least the approximate exchange value, (iii) communicating to the one or more human resources systems an indication of the amount of paid time off that has been flagged for donation, and (iv) generating an electronic record indicative of an electronic credit equal to the currency value;
receiving, from the one or more human resources systems, a first electronic payment of funds in an amount based at least on the determined currency value associated with the amount of paid time off to be donated;
based at least on the one or more charitable giving preferences, determining a target charitable organization; and
transmitting, to a computing system associated with the target charitable organization, a second electronic payment of funds in an amount based at least on the determined currency value associated with the amount of paid time off to be donated.

12. The computer-implemented method of claim 11, further comprising:
generating a physical voucher based on the electronic record indicative of the electronic credit, the physical voucher denoting (i) at least the determined currency value associated with the amount of paid time off to be donated and (ii) a redemption code; and
wherein the second electronic payment of funds is conditioned on receiving the redemption code from the computing system associated with the target charitable organization.

13. The computer-implemented method of claim 11, further comprising:
receiving an electronic indication representative of a third party entity's willingness to augment donations by the plurality of users; and
wherein the second electronic payment of funds is in an amount based at least on (i) the amount of paid time off to be donated and (ii) the electronic indication representative of the third party entity's willingness to augment donations by the plurality of users.

14. The computer-implemented method of claim 11, further comprising:
providing a user interface to the plurality of users, the user interface displaying at least (i) information associated with the one or more charitable organizations and (ii) information maintained in the one or more user profiles.

15. The computer-implemented method of claim 13, further comprising:
maintaining, in each user profile of the one or more user profiles, a virtual currency amount having a value; and
electronically tracking activities of one or more users of the plurality of users on the one or more user profiles; and
increasing the value of the virtual currency amount maintained on a user's profile when one or more electronic requests are successfully processed or when the activities are detected.

16. The computer-implemented method of claim 15, wherein the tracked activities include at least one of (i) accessing the system, (ii) providing one or more electronic comments, (iii) providing one or more electronic reviews, and (iv) providing one or more electronic updates.

17. The computer-implemented method of claim 14, wherein the user interface includes a display ranking the one or more user profiles based on the value of the virtual currency amount maintained on the one or more user profiles.

18. The computer-implemented method of claim 11, wherein the one or more processors are configured for integration with one or more statistical information databases and one or more publication databases, and the method further comprises:
retrieving statistical information from the one or more statistical information databases related to one or more factors associated with human development, the one or more factors including at least one of economic factors, health factors, education factors, and environmental factors;
retrieving publication information from the one or more publication databases;
providing a user interface to the plurality of users, the user interface displaying at least (i) information associated with the one or more charitable organizations and (ii) information maintained in the one or more user profiles, and the user interface configured for receiving one or more crowd-sourced updates from the one or more users, the crowd-sourced updates indicative of (i) a severity level of an event, (ii) the location of the event, (iii) whether the event is beneficial or deleterious and (iv) a time of when a crowd-sourced update was provided;
using machine-reading techniques, automatically processing the publication information to extract information indicative of (i) the severity level of an event, (ii) the location of the event, (iii) whether the event is beneficial or deleterious and (iv) a time indicative of when the publication was published;
determining one or more numerical scores based at least on (i) the retrieved statistical information, (ii) the processed publication information and (iii) the one or more crowd-sourced updates, each of the one or more numerical scores associated with one or more regions and indicative of a level of need for charitable aid in the one or more regions; and
providing the one or more numerical scores to the user interface.

19. The computer-implemented method of claim 18, wherein the target charitable organization is automatically determined without user input using at least both (i) one or more numerical scores and (ii) the one or more indications of charitable giving preferences.

20. The computer-implemented method of claim 18, wherein each factor of the one or more factors is associated with a weighting, and the method further comprises:
modifying the weighting associated with each factor of the one or more factors based on the one or more indications of charitable giving preferences.
